(19) United States
(12) Patent Application Publication
(10) Pub. No.: US 2024/0285037 A1
(43) Pub. Date: Aug. 29, 2024

(54) A Footwear Manufacturing System

(71) Applicant: ECCO SKO A/S, Bredebro (DK)

(72) Inventor: Thomas Gogsig, Bredebro (DK)

(21) Appl. No.: 18/572,976

(22) PCT Filed: Jun. 23, 2022
(86) PCT No.: PCT/DK2022/050140

§ 371 Date: Dec. 21, 2023

(30) Foreign Application Priority Data
Jun. 23, 2021 (DK) PA 2021 70322

(51) Int. Cl. A43D 111/00; A43D 119/00

(52) U.S. Cl. CPC A43D 111/00; A43D 119/00

(57) ABSTRACT

A footwear manufacturing system includes a footwear assembly, a footwear identification representation associated with the footwear assembly, a plurality of footwear manufacturing locations, and a footwear manufacturing line for conveying the footwear assembly between the plurality of footwear manufacturing locations under control by a system controller and/or a robot controller. The system controller is configured to monitor the footwear assembly when the footwear assembly is transported from a first location of the plurality of footwear manufacturing locations to a second location of the plurality of footwear manufacturing locations based on the footwear identification representation.

### FIELD OF THE INVENTION

The present invention relates to a footwear manufacturing system according to claim 1.

### BACKGROUND OF THE INVENTION

It is well-known to apply robots for the manufacture of footwear.

An example of such application is described in US 2021018893A1. The disclosed system applies automation in relation to process steps to be performed during manufacturing of footwear. A problem related to the illustrated system is that the overall manufacturing line is inflexible and the system is subject to “clogging” of the manufacturing line, thereby reducing the overall efficiency of the system.

Another example of such application is described in CN103099390B B. This application discloses a way of integrating an ID with a footwear to be manufactured and the footwear assembly thus “instructs” the footwear manufacturing device to perform relevant process steps. This system also partly enjoys the benefit of using a footwear manufacturing for automatic implementation of process steps, the efficiency of the manufacturing system in in practice not very high.

### SUMMARY OF THE INVENTION

The invention relates to a footwear manufacturing system comprising:
a footwear assembly (FA);
a footwear identification representation (ID; IDX; IDY) associated with said footwear assembly;
a plurality of footwear manufacturing locations (FML);
a footwear manufacturing line (FLINE) for conveying said footwear assembly between said plurality of footwear manufacturing locations (FML) under control
by a system controller (SCON) and optionally also by a robot controller associated with footwear manufacturing location; and wherein
the system controller (SCON) being configured to monitor said footwear assembly when the footwear assembly is transported from a first location of said plurality of footwear manufacturing locations to a second location of said plurality of footwear manufacturing locations based on said footwear identification representation.

According to an embodiment of the invention it is possible to track a footwear assembly during manufacture and it is possible to convey this information to manufacturing robots at footwear manufacturing locations and thereby automatically adapt the functioning of the footwear manufacturing robot to match the particular footwear assembly to be processed.

According to an embodiment of the invention, it is possible to route the footwear assembly between different footwear manufacturing locations on the basis of a footwear identification representation associated with said footwear assembly. Such identification representation may e.g. be hold by an RFID tag attached to and/forming part of the footwear assembly. In the present context the ID as such may be regarded as the abstraction defining a unique assembly, whereas the ID representation is regarded as the physical representation associated to the unique assembly in question and the representation may be applied as a means for associating a tangible, storable and a readable code which may be directly or indirectly be applied as an unambiguous reference to one particular footwear assembly.

Besides the possibility of routing the footwear on the basis of the ID it is now also possible to track and log manufacturing parameters such as processing location, processing robot, use of materials, processing time, etc.

The “footwear identification” representation may e.g. be carried by an RFID tag attached to and/forming part of the footwear assembly or e.g. by means of NFC enabled devices. Other ways of associating the ID to the footwear assembly in question may of course be applied within the scope of the invention. QR codes, bar codes, etc may thus also applied for laser reading.

In other words, many different ways of associating such an ID to a footwear assembly may be applied within the scope of the invention. Thus such identification information may contained or made accessible through active or passive means. It should however be taken into consideration that such means must by itself or by its implementation into a system, facilitate the system and/or a manufacturing robot at a footwear manufacturing location may easily identify (uniquely) the footwear assembly associated with the identification representation in question.

The “identification representation” will in the present context be understood as a coded information which may uniquely identify the footwear assembly to the system controller, either directly or via supplementary use of coding. Hence, when referred to as a unique ID or unique identification representation, such understanding of an ID will be applied unless otherwise noted.

This identification representation is thus a “coded version” referring to and creating a unique identity of a particular footwear assembly. This identity, i.e. the respective identification representation, may be associated with footwear assembly identification information (footwear attributes) describing and/or defining the footwear assembly structurally, but also describing and defining what process the footwear assembly went through until the assembly become finalized as the footwear finally produced.

A “footwear manufacturing line” is in the present context not only designating a conventional footwear inline assembly line, but also a branched footwear assembly line, where the individual footwear assemblies may be routed individually between different footwear manufacturing robots, including footwear robots performing the same process step/task across different models. It is also noted that the term “footwear manufacturing line” broadly designates a technical measure capable of transporting a specified footwear assembly from one footwear manufacturing robot location to another footwear manufacturing robot on another location. As long as such transport is carried out according to the provisions of the invention, transport measures may include conveyer, mobile carriages, drones, etc, as long as the footwear individual footwear assemblies are transported to the relevant and necessary footwear manufacturing robots at their respective locations in the right order. Broadly such technical measured will be referred to as carriers unless otherwise noted.

It should generally be understood according to an embodiment of the invention that the term routing will indicate that the footwear assembly's transportation path from the start/input to the final output is not given just by e.g. size and model. This means in practice that a certain footwear assembly, which according to its design is going to end up as a footwear of e.g. a certain size and as a certain model may now be associated with design information, size information, etc so that a (unique) identification representation stored in a database accessible for the system controller and thereby facilitating that the system controller can lead the footwear assemblies to and through the required manufacturing steps (elsewhere referred to as “instructions”)—but also in the right order. It should however be noted that this routing of the footwear assemblies may be delegated also to robot controllers which may in principle autonomously send the footwear assembly from one robot to another footwear manufacturing location. It is however noted that this would involve both that a system controller is facilitating a general transport of footwear assemblies on an associated footwear manufacturing line with as little clogging or conflicting between the footwear assemblies/the footwear assembly carriers carrying the footwear assembles. This may be understood in plain terms as an operation system which at least to some degree must be referred to the system controller.

Different models, i.e. model designs, may for example be assembled of different footwear parts to provide different properties or different aesthetic looks. A model design of one footwear may for example be based on an upper assembled by one number of pieces (e.g. 3 leather pieces), while a model design of another footwear is based on an upper assembled by another number of pieces (e.g. 4 leather pieces). Such two footwears thus have different model designs. In contrast to two footwears of the same model design (but with different sizes), two footwears of different model designs cannot be scaled in size to match each other. Different model designs may also be assembled of differently shaped footwear parts.

A footwear manufacturing robot according to the invention may thus successively handle footwear with different model designs.

In an embodiment of the invention the footwear assemblies are transported between at least two different footwear manufacturing robots at two different locations in a carrier fixating the orientation of the footwear assembly relative to the carrier.

A “footwear assembly” within the context of the present invention is understood broadly at a gathering of a number of footwear parts at any time during manufacture of a footwear from the time initial footwear parts has been gathered or prepared, even before mutual attachment of the gathered footwear parts, e.g. by stitching until a final footwear has been mounted with a sole and footwear has been finished and ready for packaging. In other words, when a footwear assembly proceeds during a manufacturing process, components and features may be accumulated into the footwear assembly and the footwear assembly be further processed.

It is noted that the footwear assembly in a preferred embodiment of the invention is uniquely defined/identified across not only sizes or variants of a footwear model but also across footwear models.

In other words, the ID—or in practice the associated identification representation—may be applied for a combined setting the programs of the respective footwear manufacturing robot and also an automatic routing of the footwear further along the manufacturing process.

In an embodiment of the invention the system controller (SCON) and/or said robot controller being configured to control transporting of said footwear assembly from a first location (FLOC) of said plurality of footwear manufacturing locations to a second location (SLOC) of said plurality of footwear manufacturing locations based on said footwear identification representation (ID: IDX, IDY).

In an embodiment of the invention the system controller (SCON) is configured to control transporting of said footwear assembly from a first location (FLOC) of said plurality of footwear manufacturing locations to a second location (SLOC) of said plurality of footwear manufacturing locations based on said footwear identification representation, the second footwear manufacturing location being one of a least two different alternative possible footwear manufacturing locations.

In an embodiment of the invention the robot controller (SCON) is configured to control transporting of said footwear assembly from a first location (FLOC) of said plurality of footwear manufacturing locations to a second location (SLOC) of said plurality of footwear manufacturing locations based on said footwear identification representation, the second footwear manufacturing location being one of a least two different alternative possible footwear manufacturing locations.

In an embodiment of the invention the footwear assembly is monitored by reading an ID marking (IDM) attached to the footwear assembly and/or reading an ID marking (IDM) attached to footwear part(s) to be gathered with and attached to the footwear assembly.

In an embodiment of the invention, the ID marking may contain the complete system identification representation. Alternatively, it may also carry a part of the representation as long as a complete unique identification may be generated and applied by the system, so the every footwear assembly be unambiguously be identified during or after the manufacturing process.

In an embodiment of the invention the footwear assembly is monitored by reading an ID marking (IDM) attached to the footwear assembly and/or reading an ID marking attached to footwear part(s) to be gathering with and attached to the footwear assembly and wherein the footwear assembly is monitored at least one time during transport from the first location to the second location on the basis of an associated marking or transport information communicated to the system controller SCON.

In an embodiment of the invention said footwear manufacturing line including a plurality of footwear assembly carriers (FAC) configured for transporting footwear assemblies between at least a subset of said footwear manufacturing locations (FML) under control by said system controller (SCON).

The carriers may be implemented and adapted for the particular transporting purposes of the footwear assembly. In the initial part of the process, footwears assembly parts may e.g. be carried in trays or frames, whereas the upper may e.g. be carried on lasts prior to and subsequent to the attachment of the sole to the upper, e.g. by injection molding onto the upper or by cementing a sole to the upper. Different carriers may be applied for different purposes as long as they are under control and/or monitored by the system controller. Moreover, the carriers should preferably be adapted for automatic handling at the footwear manufacturing locations. It should of course be noted that some parts of the processing of the footwear assemblies at different footwear manufacturing locations may be performed automatic as long as the transporting between the footwear manufacturing locations are performed automatically under the control of the system controller. In this context it should be noted that the automatic transport be footwear manufacturing locations may of course be initiated manually, e.g. a manual robot manufacturing location, if this is considered advantageous, but the routing of the footwear assemblies should be controlled by the system controller in order to obtain an advantageous and optimized efficiency of the transport system and the footwear manufacturing robots of the footwear manufacturing line.

In this context it should be noted that the footwear manufacturing line is preferably not just implemented as an inline system as the system may be implemented with multiple breakout points and multiple different ways of routing options, even for footwear assemblies of the same model/model design.

In an embodiment of the invention the footwear identification representation is applied for automatic reconfiguration of a footwear manufacturing robot (FMR) based on said footwear identification representation when the respective footwear assembly is in proximity of the location of said footwear manufacturing robot.

In an embodiment of the invention the footwear identification representation is applied for automatic initialization of a reconfiguration of a footwear manufacturing robot (FMR) based on said footwear identification representation before the respective footwear assembly is in position for processing by means of said footwear manufacturing robot at the footwear manufacturing location.

In an embodiment of the invention, the footwear identification representation of a footwear assembly is correlated to at least one footwear assembly attribute (FAA).

In an embodiment of the invention, the footwear identification representation of a footwear assembly is correlated to at least one footwear assembly attribute, said footwear assembly attribute including footwear assembly model (FAM).

In an embodiment of the invention the footwear identification representation of a footwear assembly is correlated to at least one further footwear assembly attribute, said further footwear assembly attribute including footwear assembly size (FAS).

In an embodiment of the invention, the footwear manufacturing line (FLINE) is configured for automatically routing a plurality of footwear assemblies (FA) between said footwear manufacturing robots (FMR) at corresponding different footwear manufacturing locations (FML) based on said footwear identification representation (FIR).

In an embodiment of the invention the footwear manufacturing line (FLINE) is configured for automatically routing a plurality of footwear assemblies (FA) between said footwear manufacturing robots (FMR) at corresponding different footwear manufacturing locations (FML) based on said footwear identification representation (FIR) and wherein the footwear manufacturing system comprises a plurality of footwear manufacturing robots configured for performing a first process step (FPS) and wherein the wherein the footwear manufacturing system comprises a plurality of footwear manufacturing robots configured for performing a second process step (SPS), wherein the first process step is functionally different than the second process step (SPS).

The terminology “process step” in the present context is to be understood as one of a series of footwear manufacturing instructions to be performed in order to manufacture the intended footwear. The term “functionally different” is intended designate that the process steps are different, i.e. different footwear manufacturing instructions. Different process steps could e.g. be stitching, lasting, molding, trimming, polishing, de-lasting etc. Another way of understanding “functionally different” is that the different footwear manufacturing instructions are carried out with different tools/types of tools.

In an embodiment of the invention, the footwear manufacturing line (FLINE) is configured for automatically routing a plurality of footwear assemblies (FA) between said footwear manufacturing robots (FMR) at corresponding different footwear manufacturing locations (FML) based on said footwear identification representation (FIR) and wherein the footwear assemblies are transported by footwear assembly carriers (FAC) between the footwear manufacturing locations (FML) controlled by the system controller SCON.

In an embodiment of the invention, the footwear assembly carriers (FAC) are configured for carrying one or a pair of footwear assemblies between the footwear manufacturing locations (FML).

In a part or in parts of the total process flow, the footwear assemblies may advantageously be transported one by one by respective individual carriers. In this part of the process the footwear assemblies may be individually carried by lasts, which again are carried by carriers automatically controlled by the system controller.

In an embodiment of the invention, the footwear assembly carriers (FAC) are configured for carrying a plurality of footwear assemblies between the footwear manufacturing locations (FML).

In a part or in parts of the total process flow, the footwear assemblies may advantageously be transported between manufacturing locations by carriers carrying a plurality of footwear assemblies, e.g. 10, 20, 50 or 100 footwear assemblies. These carriers may preferably be automatically controlled by the system controller, although it is possible the some relatively few transports are carried out manually as long as the system controller has the overall monitoring and routing ability for the automatic processes carried out just before and just after such manual part process.

In an embodiment of the invention, the footwear carriers are configured as a multiple of transportation paths (TP) between said footwear manufacturing locations (FML) and wherein said transportation paths are branched so as to switch footwear assembly carriers (FAC) between different alternative footwear manufacturing locations for the same process step/task.

In the present context the “same task” is e.g. understood as a certain required process step, a footwear manufacturing instruction belonging to a series of footwear manufacturing instructions required to obtain a final footwear on the basis of the particular footwear assembly. Such “same task” could thus for example be an automatic trimming operation related to the footwear assembly in question and this same operation may now be performed not only by one footwear manufacturing robot but by two or more footwear manufacturing robots. The system controller is thus able not only to route or apply an inline robot, but is able to distribute the particular task of trimming to more than one alternative footwear manufacturing robots setup for trimming.

It should be noted that the alternative footwear manufacturing robots, in such a routing system advantageously in the specific embodiment should be able to switch between different “tasks”, i.e. in the specific embodiment e.g. perform trimming on footwear assemblies of different models, thereby facilitating “multi-model” routing in the footwear manufacturing line, at the same time. This has the impact that the footwear manufacturing line may route different models at the same time.

Moreover, the invention relates to method for manufacturing footwear in a system according to any of the claims 1-30, whereby the transportation of individual footwear assemblies (FA) are monitored during the transport through the footwear manufacturing line (FLINE).

In an embodiment of the invention, the transportation of individual footwear assemblies (FA) are monitored during the transport through the footwear manufacturing line (FLINE) and whereby the individual footwear assemblies are routed through a branched transportation path by the system controller.

The inventors have identified the above-mentioned problems and challenges related to manufacturing footwear, and subsequently made the below-described invention which may increase efficiency and flexibility.

The invention relates to a footwear manufacturing robot system comprising:
an automated footwear manufacturing robot;
a robot controller configured to control said automated footwear manufacturing robot;
a robot instructions database comprising a plurality of robot manufacturing instructions; and
a system controller communicatively coupled to said robot instructions database and said robot controller;
   wherein said automated footwear manufacturing robot is configured to manufacture different footwear assemblies at least partially, each of said different footwear assemblies associated with footwear assembly identification information,
   wherein said system controller is configured to select an elected manufacturing instruction of said plurality of robot manufacturing instructions based on said footwear assembly identification information,
   wherein said robot controller is configured to automatically execute said elected manufacturing instruction to operate said automated footwear manufacturing robot.

A footwear manufacturing robot system according to the invention may be capable of performing multiple different operations relating to manufacturing of footwear, which is advantageous.

By basing an elected manufacturing instruction on footwear assembly identification information, it is possible to identify an applicable robot manufacturing instruction, i.e. an elected manufacturing instruction. Accordingly, a footwear manufacturing robot system according to the invention may be capable of dynamically manufacturing of different footwear, such as footwear with different models designs, male/female models, and sizes, even though such manufacturing require different robot manufacturing instructions, which is advantageous. Such different robot manufacturing instructions may for example involve different movement trajectories of the automated footwear manufacturing robot, different appliance of material (glue, injection, surface treatment), different tools, etc.

To manufacture footwear, multiple different manufacturing operations are typically necessary, for example cutting, stitching, adhering, moulding, lacing, and brushing. By having a footwear manufacturing robot system according to the invention which provides access to a plurality of robot manufacturing instructions, it may be possible for an automated footwear manufacturing robot to perform several of such different manufacturing operations during manufacturing, which is advantageous. This may in turn generally increase flexibility and efficiency of manufacturing of footwear, which is advantageous. The invention may for example be implemented to remove bottlenecks in footwear manufacturing.

Furthermore, by having a system controller which regularly selects an elected manufacturing instruction based on footwear assembly identification information, it is possible to track operation of complex footwear manufacturing robot systems, which is advantageous. Such tracking may further permit optimization of such systems, which is advantageous.

Additionally, footwear manufacturing robot systems according to the invention may generally improve flexibility of footwear production and minimize risk of producing surplus footwear which is an environmental waste.

An automated footwear manufacturing robot may be understood as an automated machine capable of performing one or more footwear-related manufacturing operations, e.g. based on robot manufacturing instructions.

A robot controller may be understood as a controller for the automated footwear manufacturing robot. It may for example facilitate control of actuation of the robot and/or control of tools of the robot. It may be an integrated part of the automated footwear manufacturing robot, or it may be a separate unit.

A footwear assembly may be understood as an intermediate assembly of one or more footwear parts during the manufacturing of a footwear. A footwear assembly may further comprise a carrier such as a, fixture, a jig, a last, a transportation vehicle, or other components assisting the manufacture. To produce a footwear, a footwear assembly may typically go through a series of footwear-related manufacturing operations manufacturing. A footwear assembly relating to the footwear to be produced may thus go through this series of operations to eventually output a footwear. During the series of operations, the footwear assembly may, for example, gradually receive additional footwear parts, be transferred from one component (e.g. jig) to another (e.g. last), and receive surface treatment (e.g. grinding or polishing). Consequently, the footwear assembly as gradually changed throughout the manufacturing process. Nevertheless, the invention may relate to manufacturing of any of the intermediate states of such a footwear assembly.

Robot manufacturing instructions may be understood as footwear-related operations which the automated footwear manufacturing robot is capable of carrying out. Robot manufacturing instructions may further be executable by the robot controller, e.g. upon executing a robot manufacturing instruction by the robot controller, the robot controller controls the automated footwear manufacturing robot, such that the automated footwear manufacturing is operated, i.e. it performs an operation matching the robot manufacturing instruction. A plurality of robot manufacturing instructions may be understood as a group of different robot manufacturing instructions which the automated manufacturing robot is capable of carrying out.

An elected manufacturing instruction may be understood as a robot manufacturing instruction of the plurality of robot manufacturing instructions which has been selected to be carried out by the automated footwear manufacturing robot. The selection may be based on the footwear assembly identification information, for example, based on this information, the system controller can identify which manufacturing instruction is necessary for the next manufacturing step of a given footwear assembly. Resultingly, the automated footwear manufacturing robot may thus for example carry out different operations for different footwear with different footwear assembly identification information. In some embodiments, the footwear assembly identification information is associated with footwear manufacturing instructions, which are necessary for at least partially manufacturing of a certain footwear, and the elected manufacturing instructions correspond to one of these footwear manufacturing instructions. For example, a footwear manufacturing instruction may relate to a certain stitching instruction, the robot manufacturing instructions relate to a plurality of different stitching instructions, where one of these different stitching instructions match the certain stitching instruction, and accordingly, the matching stitching instruction of the robot manufacturing instructions is selected as the elected manufacturing instruction, upon which the automated footwear manufacturing robot is operated.

A footwear manufacturing instruction may be understood as an instruction relating to a footwear-related operation of an arbitrary automated footwear manufacturing robot, for example to further manufacture a footwear of a footwear assembly associated with the footwear manufacturing instruction. A series of footwear manufacturing instructions may be understood as several different footwear manufacturing instructions relating to the same footwear or footwear assembly. In this context, a series is not restricted to a particular number, e.g. may be 1, 2, 3, 4, from 5 to 9, from 10 to 20, or more than 20 footwear manufacturing instructions. A footwear or footwear assembly may thus be associated with a series of manufacturing instructions which is necessary to at least partly manufacture the footwear via one or more automated footwear manufacturing robots.

A footwear manufacturing instruction is not necessarily in itself an executable footwear-related instruction but may simply be linked or associated with a robot manufacturing instruction which can potentially be executed by a robot controller to operate an automated footwear manufacturing robot.

In some embodiments, a plurality of robot manufacturing instructions relate to available parameter spaces of the automated footwear manufacturing robot or constraints within which the robot is capable of operating. For example, a pick-and-place robot is capable of moving footwear parts complying with a maximum size and weight of the parts, from one constrained location to another constrained location.

Selecting an elected manufacturing instruction may optionally be associated with at least some automated programming within such parameter spaces and constraints.

Footwear assembly identification information associated with a footwear assembly may be understood as information indicative of model design, size, colour, materials, footwear type, male/female/unisex model, unique assembly ID, unique footwear assembly ID, or any combination thereof of the footwear assembly or the footwear which is to be produced from the footwear assembly. Such information may for example be stored in a database, e.g. an identification information database, which is accessible to the system controller. The information may be accessible via the footwear assembly, e.g. via reading an RFID on the footwear assembly. Such a reading can directly provide the information or link the footwear assembly to the information stored in an identification information database. However, embodiments of the invention do not necessarily rely on reading information via the footwear assembly. Instead, the system controller may keep track of each individual footwear assembly, such that it is capably of linking the each footwear assembly to its associated footwear assembly identification information.

Generally, a robot manufacturing instruction may be related to a robot program which is readable by the robot controller to operate the automated footwear manufacturing robot. The robot manufacturing instruction itself may or may not be directly readable by the robot controller. If it not readable, it may instead be associated with a readable robot program. A robot manufacturing instruction may thus at least be indicative of an associated or related readable robot program. And when the robot controller runs such an associated readable robot program, it may thus operate the automated footwear manufacturing robot according to the robot manufacturing instruction, for example if a robot manufacturing instruction has been selected as an elected manufacturing instruction.

Manufacturing instructions (robot, footwear, and elected) may also be referred to as process steps, for example a footwear process step, e.g. a footwear manufacturing instruction relating to trimming may also be referred to as a footwear process step relating to trimming, e.g. a trimming process step.

A robot instructions database may be understood as digital storage, which digitally stores robot manufacturing instructions, or representations of the robot manufacturing instructions.

In embodiments of the invention, one or more databases may be distributed among one or more hard disc drives for digital storage. Thus, one database does not necessarily rely on one single storage, and one single storage may store several databases.

A system controller may be understood as a controller for selecting an elected manufacturing instruction based on footwear assembly identification information. Such a selection may typically be performed digitally and automatically. The system controller may for example be a part of a manufacturing execution system. It may work in real time, to select one elected manufacturing instruction at a time for each footwear assembly which are to be handled by the automated footwear manufacturing robot. A system controller may simultaneously facilitate selection of elected manufacturing instructions of several automated footwear manufacturing robots. To perform the task of selecting an elected manufacturing instruction, the system controller is typically based on a processer, which is able to process the plurality of robot manufacturing instructions and the footwear assembly identification information.

A system controller may further be capable of digitally comparing stored robot manufacturing instructions and digitally stored footwear manufacturing instructions to autonomously select an elected manufacturing instruction of the robot manufacturing instructions.

Generally, the system controller and the robot instructions database may be a part of a computer architecture, capable of facilitating at least a part of the invention. Other suitable parts of the invention, such as a robot controller, may also be part of the computer architecture. Such a computer architecture may for example comprise one or more servers, processors, workstation/user interface, digital storage/memory, executable programs, communication channels, etc.

In typical embodiments, the robot controller and the system controller are separate controllers, but in some embodiments, the two controllers are integrated in a single controller.

In an embodiment of the invention, said system controller is configured to select said elected manufacturing instruction of said plurality of robot manufacturing instructions based on said footwear assembly identification information of a target footwear assembly of said different footwear assemblies.

In an embodiment of the invention, said robot controller is configured to automatically execute said elected manufacturing instruction to operate said automated footwear manufacturing robot to at least partially manufacture said target footwear assembly.

In an embodiment of the invention, said footwear manufacturing robot system further comprises a footwear manufacturing line for conveying said different footwear assemblies between a plurality of manufacturing locations, wherein said automated footwear manufacturing robot is located at a robot manufacturing location of said plurality of manufacturing locations.

A “footwear manufacturing line” is in the present context not only designating a conventional footwear inline assembly line, but also a branched footwear assembly line, where the individual footwear assemblies may be routed individually between different footwear manufacturing robots, including footwear robots performing the same task across different models. It is also noted that the term “footwear manufacturing line” broadly designates a technical measure capable of transporting a specified footwear assembly from one footwear manufacturing robot location to another footwear manufacturing robot on another location. As long as such transport is carried out according to the provisions of the invention, transport measures may include conveyer, mobile carriages, drones, etc, as long as the footwear individual footwear assemblies are transported to the relevant and necessary footwear manufacturing robots at their respective locations in the right order/sequence. Broadly such technical measured will be referred to as carriers unless otherwise noted.

In a part or in parts of the total process flow, the footwear assemblies may advantageously be transported one by one by respective individual carriers. In this part of the process the footwear assemblies may be individually carried by lasts, which again are carried by carriers automatically controlled by the system controller.

In a part or in parts of the total process flow, the footwear assemblies may advantageously be transported between manufacturing locations by carriers carrying a plurality of footwear assemblies, e.g. 10, 20, 50 or 100 footwear assemblies. These carriers may preferably be automatically controlled by the system controller, although it is possible the some relatively few transports are carried out manually as long as the system controller has the overall monitoring and routing ability for the automatic processes carried out just before and just after such manual part process.

In an embodiment of the invention, said different footwear assemblies are transported by footwear assembly carriers on said footwear manufacturing line.

A footwear assembly carrier may for example carry one or a pair of footwear assemblies.

In an embodiment of the invention, said footwear manufacturing line is at least partly controlled by said system controller.

In an embodiment of the invention, said system controller is further configured to route said target footwear assembly to said robot manufacturing location to establish a target assembly route upon selecting said elected manufacturing instruction.

When an elected manufacturing instruction has been selected, the footwear assembly may further route the target footwear assembly to the automated footwear manufacturing robot, which is advantageous. By routing, a target assembly route is established, which is indicative of the path which the target footwear assembly has to travel to arrive at the automated footwear manufacturing robot. The target assembly route may further be readable/executable by the footwear manufacturing line, such that the line can autonomously convey the target footwear assembly to the automated footwear manufacturing robot.

In an embodiment of the invention, said target assembly route comprises one or more branch selections associated with one or more branched modules of said footwear manufacturing line.

Some footwear manufacturing lines may have branches/branched modules, at which the footwear assemblies can be conveyed towards different manufacturing locations. Advantageously, a target assembly route may comprise one or more branch selections, which are indicative of which of the branched paths of the branches that the target footwear assembly has to travel to arrive at the automated footwear manufacturing robot.

In an embodiment of the invention, said target assembly route passes one or more other footwear manufacturing robots.

In an embodiment of the invention, said target assembly route passes one or more non-elected manufacturing locations of said plurality of manufacturing locations.

By passing one or more other footwear manufacturing robots (or non-elected manufacturing locations), the target footwear assembly may be conveyed directly to the automated footwear manufacturing robot, which is advantageous.

In an embodiment of the invention, said footwear manufacturing robot system is configured to generate an idle signal after completion of executing said elected manufacturing instruction to operate said automated footwear manufacturing robot.

In an embodiment of the invention, said system controller is configured to select a new elected manufacturing instruction of said plurality of robot manufacturing instructions after reading said idle signal.

In a footwear manufacturing robot system as offered by the invention, dynamical manufacturing of different footwear may be permitted. In such cases, generating an idle signal is advantageous, since it may permit the footwear manufacturing robot system that the automated footwear manufacturing robot is now available for a new footwear assembly.

The idle signal may be generated by the automated footwear manufacturing robot, the robot controller, the system controller, or another unit of the system. The appearance of the idle signal may for example be read by the system controller, or a reading may at least be forwarded to the system controller, such that is can select a new elected manufacturing instruction, for example such that the robot controller can execute the new elected manufacturing instruction to operate the automated footwear manufacturing robot.

The new elected manufacturing instruction may relate to the same footwear assembly as the elected manufacturing instruction, or it may relate to a different footwear assembly.

In an embodiment of the invention, each of said different footwear assemblies are associated with different footwear assembly identification information.

Accordingly, a different elected manufacturing instruction can be selected for each footwear assembly, if necessary for manufacturing, which is advantageous.

In an embodiment of the invention, said footwear manufacturing robot system further comprises an assembly identification receiver for receiving input from said target footwear assembly to link said target footwear assembly to said footwear assembly identification information.

An assembly identification receiver is capable of receiving/reading footwear assembly identification information of the footwear assembly. Thus, it may be possible to identify presence, type, size, and/or unique ID of the footwear assembly, which is advantageous.

An assembly identification receiver may for example be based on machine vision, or simpler approaches such as reading an identity marking such as a barcode, a QR code, or an RFID on or near the footwear assembly.

An assembly identification receiver may also be understood as an identity reader.

In an embodiment of the invention, said assembly identification receiver is associated with an assembly identification transmitter.

The transmitter and the receiver may work together to receive input from the target footwear assembly to link the target footwear assembly to the footwear assembly identification information. The transmitter and the receiver may be a combined transceiver. The transmitter may emit radiofrequency radiation, LED radiation, laser radiation, etc.

In an embodiment of the invention, said assembly identification receiver is an RFID reader.

RFID is particularly advantageous, since such an ID can be integrated in the footwear in an unseeable manner, such that it can be utilized both during manufacturing, and during use by the consumer. A consumer may for example use the RFID to receive information relating to the type of footwear, or even the unique footwear, such as manufacturing information. Such manufacturing information may for example be production location, environmental/carbon footprint, footwear trivia etc.

In an embodiment of the invention, said assembly identification receiver is communicatively connected to said system controller.

Accordingly, the system controller may be capable of retrieving relevant information based on input from the assembly identification receiver, e.g. retrieving footwear assembly identification information or a series of footwear manufacturing instructions, which is advantageous.

In an embodiment of the invention, said footwear assembly identification information is associated with a series of footwear manufacturing instructions of said target footwear assembly.

In an embodiment of the invention, each of said different footwear assemblies are respectively associated with different series of footwear manufacturing instructions.

In an embodiment of the invention, said different series of footwear manufacturing instructions are associated with said footwear assembly identification information.

In an embodiment of the invention, said system controller is configured to identify said series of footwear manufacturing instructions associated with said target footwear assembly based on said footwear assembly identification information.

By associating the footwear assembly identification information with the footwear manufacturing instructions, it is possible for the footwear manufacturing robot system to commence a comparison of the plurality of robot manufacturing instructions with the series of footwear manufacturing instructions based on the footwear assembly identification. Further, in systems with a plurality of series of footwear manufacturing instructions (e.g. different series), it is possible to identify, e.g. by the system controller, which of the series of footwear manufacturing instructions are relevant for the comparison.

Typically, any series of footwear manufacturing instructions are digitally stored in one or more footwear instruction databases communicatively connected to the system controller. However, the footwear manufacturing instructions may alternatively be stored elsewhere, for example in the RFID of a footwear assembly which also provides the footwear assembly identification information.

In alternative embodiments, the system controller or an associated manufacturing execution system tracks individual footwear assemblies of the manufacturing system. The tracking may for example be performed by controlling movement of autonomous vehicles of the individual footwear assemblies, which in turn grant positional information of each unique footwear assembly. This information can then be used by the system controller to compare relevant robot manufacturing instructions with relevant footwear manufacturing instructions.

By instead having an assembly identification receiver, the system controller or an associated manufacturing execution system does not need a track record of each individual footwear assembly. Accordingly, a footwear manufacturing robot system can simply receive the footwear assembly identification information of a footwear assembly and consequently carry out operation.

In an embodiment of the invention, a mathematical set formed by said series of footwear manufacturing instructions and a mathematical set formed by said plurality of robot manufacturing intersect to form an instruction set intersection.

In an embodiment of the invention, the elected manufacturing instruction is selected from the instruction set intersection.

In an embodiment of the invention, the relative complement of said mathematical set formed by said series of footwear manufacturing instructions in said mathematical set formed by said plurality of robot manufacturing is non-empty.

In an embodiment of the invention, the relative complement of said mathematical set formed by said plurality of robot manufacturing instructions in said mathematical set formed by said series of footwear manufacturing is non-empty.

A mathematical set may be interpreted in context of set theory of mathematical logic.

In an embodiment of the invention, said system controller is configured to compare said plurality of robot manufacturing instructions with said series of footwear manufacturing instructions to select said elected manufacturing instruction.

By comparing said plurality of robot manufacturing instructions with the series of footwear manufacturing instructions, it may be possible to suitably and efficiently select an elected manufacturing instruction, which is advantageous.

In an embodiment of the invention, said system controller is configured to compare said plurality of robot manufacturing instructions with said series of footwear manufacturing instructions to select said elected manufacturing instruction based on one or more selection criteria.

In an embodiment of the invention, said system controller is configured to compare said plurality of robot manufacturing instructions with said different series of footwear manufacturing instructions to select said elected manufacturing instruction based on one or more selection criteria.

By having selection criteria, selection of an elected manufacturing instruction may be optimized, and it may be possible to handle scenarios where several robot manufacturing instructions are applicable.

In an embodiment of the invention, said one or more selection criteria comprise identifying a footwear manufacturing instruction of said series of footwear manufacturing instructions among said plurality of robot manufacturing instructions.

In some embodiments, a particular footwear manufacturing instruction may relate directly to a particular robot manufacturing instruction. Thus, selecting the elected manufacturing instruction becomes a task of identifying the particular robot manufacturing instruction.

In an embodiment of the invention, said one or more selection criteria comprises a footwear manufacturing sequence of said series of footwear manufacturing instructions.

A part of or the entire series of footwear manufacturing instructions may have a particular sequence in which the footwear manufacturing instructions have to be executed. For example, an upper may have to be at least partially assembled and a sole may have to be provided before the upper and the sole can be mounted together via direct injection processing. Taking a footwear manufacturing sequence into account when selecting an elected manufacturing instruction may thus ensure that footwear is correctly manufactured, which is advantageous.

In an embodiment of the invention, said one or more selection criteria comprises comparing robot manufacturing durations of said plurality of robot manufacturing instructions.

The durations of various operations may determine how rapidly a footwear assembly can be forwarded in a manufacturing system. Thus, taking manufacturing durations into account is advantageous. For example, if two footwear assemblies have two different footwear manufacturing instructions associated with a short and a long duration, respectively, the system controller may select an elected manufacturing instruction corresponding to the short duration. Accordingly, the footwear assembly having a footwear manufacturing instruction associated with a short duration may quickly receive operation and be forwarded to a next operation at another robot, and, resultingly, waiting time for the other footwear assembly may be short.

In an embodiment of the invention, said one or more selection criteria comprises comparing footwear assembly priorities associated with said different footwear assemblies.

Some types of footwear assemblies may have a higher priority in production, for example if this footwear is required to be shipped out of the manufacturing factory before a certain deadline, or simply as fast as possible. Accordingly, footwear assemblies may have different footwear priorities, upon which the system controller can select an elected manufacturing instruction. This enables flexible manufacturing, which is advantageous.

In an embodiment of the invention, said one or more selection criteria comprises comparing physical locations of said different footwear assemblies.

For example, if a first footwear assembly is physically closer to the automated footwear manufacturing robot than a second footwear assembly, an elected manufacturing instruction relating to the first footwear assembly may be selected, which may advantageously ensure fast production.

In an embodiment of the invention, said one or more selection criteria comprises comparing idle status of said different footwear assemblies.

For example, a first footwear assembly currently being manufactured by an auxiliary footwear manufacturing robot is not idle, whereas a second footwear assembly not being manufactured is idle. The system controller may then select an elected manufacturing instruction matching a footwear manufacturing instruction of the idle footwear assembly.

Note the various selection criteria may be combined, e.g. using different selection criteria priorities, sequences, or weights.

In an embodiment of the invention, said different footwear assemblies are associated with a footwear property, wherein said different footwear assemblies have at least two unique characteristics of said footwear property.

In an embodiment of the invention, said at least two unique characteristics is at least three unique characteristics, for example at least four unique characteristics, for example at least five unique characteristics, such as more than five unique characteristics.

Examples of footwear properties are model design, footwear size, footwear colour, footwear material, model type, footwear type, and footwear assembly ID.

The different footwear assemblies having at least two unique characteristics of a footwear property may for example be the different footwear assemblies having at least two unique characteristics of footwear size, e.g. the different footwear assemblies have at least two unique footwear sizes, e.g. one footwear assembly corresponds to footwear of size 42 and another footwear assembly corresponds to size 44 (examples given in Euro sizes). Note that several different footwear assemblies having the same footwear size, e.g. 43, corresponds to one unique footwear size. A number of different footwear assemblies having two unique characteristics of a footwear property (e.g. footwear size) are thus not limited to only two footwear assemblies, since several of these footwear assemblies can have the same characteristics. E.g. an ensemble of different footwear assemblies having sizes 41, 42, 42, 42, 42, 43, 44, 44, 45, 45, and 46 have six unique characteristics (41,42,43,44,45,46) of footwear size.

Having a footwear manufacturing robot system being able to at least partially manufacture different footwear assemblies with unique footwear characteristics is advantageous since it increases flexibility of the system.

In an embodiment of the invention, said footwear assembly identification information is associated with said at least two unique characteristics of said footwear property.

In an embodiment of the invention, said plurality of robot manufacturing instructions is related to said at least two unique characteristics of said footwear property.

By having the robot manufacturing instruction being related to the unique characteristics, it is possible to rapidly switch between footwear assemblies with different unique characteristics by successively selecting different elected manufacturing instructions, which is advantageous.

In an embodiment of the invention, said different series of footwear manufacturing instructions is related to said at least two unique characteristics of said footwear property.

Different series of footwear manufacturing instructions may further relate too unique characteristics, for example a first series of footwear manufacturing instructions relate to a first unique characteristic (e.g. a first model design) and a second series of footwear manufacturing instructions relate to a second unique characteristic (e.g. a second model design). The first and second series may then relate to different footwear assemblies.

In an embodiment of the invention, said elected manufacturing instruction is related to a characteristic of said at least two unique characteristics of said footwear property.

The elected manufacturing instruction may for example relate to a characteristic of two unique characteristics of a footwear colour, e.g. relate to a first colour of two different colours.

In an embodiment of the invention, said footwear property is model design.

Different model designs may for example be assembled of different footwear parts to provide different properties or different aesthetic looks. A model design of one footwear may for example be based on an upper assembled by one number of pieces (e.g. 3 leather pieces), while a model design of another footwear is based on an upper assembled by another number of pieces (e.g. 4 leather pieces). Such two footwears thus have different model designs. In contrast to two footwears of the same model design (but with different sizes), two footwears of different model designs cannot be scaled in size to match each other. Different model designs may also be assembled of differently shaped footwear parts.

A footwear manufacturing robot according to the invention may thus successively handle footwear assemblies of two unique characteristics of model design, i.e. footwear assemblies with different model designs.

In an embodiment of the invention, said footwear property is closing system.

A closing system of a footwear may for example be a lacing-based closing system, hook-and-loop-based closing system (e.g. Velcro-based closing system), step-in closing system (e.g. including elastic bands) or any combination thereof.

A footwear manufacturing robot according to the invention may thus successively handle footwear assemblies of two unique characteristics of closing system, i.e. footwear assemblies with different closing systems.

In an embodiment of the invention, said footwear property is footwear size.

A footwear manufacturing robot according to the invention may thus successively handle footwear assemblies of two unique characteristics of footwear size, i.e. footwear assemblies with different footwear sizes.

In an embodiment of the invention, said footwear property is footwear colour.

A footwear colour may also be understood as a footwear colour composition.

A footwear manufacturing robot according to the invention may thus successively handle footwear assemblies of two unique characteristics of footwear colour, i.e. footwear assemblies with different footwear colours/colour compositions.

In an embodiment of the invention, said footwear property is footwear material.

A footwear material may also be understood as a footwear material composition.

A footwear manufacturing robot according to the invention may thus successively handle footwear assemblies of two unique characteristics of footwear material, i.e. footwear assemblies with different footwear material/colour materials.

In an embodiment of the invention, said footwear property is model type.

Model type may for example may male type, female type, or unisex type. Thus, in embodiments of the invention, the different footwear assemblies may have at least two different model types.

A footwear manufacturing robot according to the invention may thus successively handle footwear assemblies of two unique characteristics of model type, i.e. footwear assemblies with different model types.

In an embodiment of the invention, said footwear property is footwear type.

Footwear types may for example be shoes, sandals, boots, loafers, etc.

A footwear manufacturing robot according to the invention may thus successively handle footwear assemblies of two unique characteristics of footwear type, i.e. footwear assemblies with different footwear types.

In an embodiment of the invention, said footwear property is footwear assembly ID.

A footwear assembly ID may be a unique ID associated with the footwear or footwear assembly. For example via an RFID embedded in a footwear part or elsewhere on a footwear assembly. Such a footwear assembly ID may then be used to identify each different footwear assembly, for example to link the footwear assembly to its associated series of footwear manufacturing instructions. An RFID located in/on the footwear assembly may thus be indicative of the footwear assembly ID of the footwear assembly, and may for example be readable by a assembly identification receiver.

Generally, a specific footwear property of a footwear assembly may be understood as the footwear property of the resulting footwear manufactured by performing operations on that footwear assembly. E.g. a footwear assembly associated with a footwear manufacturing instructions relating to a particular footwear size may yield footwear of that particular footwear size after manufacturing.

A series of footwear manufacturing instructions may relate to other footwear properties than a plurality of robot manufacturing instructions. A series of footwear manufacturing instructions may for example relate to model deign, footwear size, footwear colour, footwear material, model (male/female/unisex), footwear type, or any combination thereof, whereas a plurality of robot manufacturing instructions only relates to a subset of these properties, for example footwear size.

In an embodiment of the invention, said footwear property is a first footwear property, wherein said different footwear assemblies are further associated with a second footwear property, wherein said first footwear property and said second footwear property are different, wherein said different footwear assemblies have at least two unique characteristics of said second footwear properties.

In an embodiment of the invention, said different footwear assemblies are further associated with a third footwear property which is different from said first footwear property and said second footwear property, wherein said different footwear assemblies have at least two unique characteristics of said second footwear properties.

In some embodiments of the invention, the footwear manufacturing robot system is not only capable of manufacturing different footwear assemblies having at least two unique characteristics of a footwear property, but further capable of manufacturing footwear assemblies having several unique characteristics of several different footwear properties.

In some embodiments, the different footwear assemblies have at least two unique characteristics of a fourth footwear property, which is different from the first, second, and third footwear property.

In some embodiments, the different footwear assemblies have at least two unique characteristics of a fifth footwear property, which is different from the first, second, third, and fourth footwear property.

The second, third, fourth, fifth, and any other footwear properties may for example be selected from the first footwear properties presented within the disclosure.

For example, different footwear assemblies having at least two unique colours and two unique sizes. Or, for example, different footwear assemblies having at least two unique model designs, two unique model types, and two unique footwear types.

In an embodiment of the invention, said footwear manufacturing robot system further comprises an identification information database comprising said footwear assembly identification information.

In an embodiment of the invention, said system controller is configured to select said target footwear assembly from said different footwear assemblies based on said footwear assembly identification information.

In an embodiment of the invention, said system controller is configured to select said target footwear assembly from said different footwear assemblies based on said series of footwear manufacturing instructions.

In an embodiment of the invention, said system controller is configured to select said target footwear assembly from said different footwear assemblies based on said different series of footwear manufacturing instructions.

In an embodiment of the invention, said system controller is configured to select said target footwear assembly from said different footwear assemblies by comparing said plurality of robot manufacturing instructions with said series of footwear manufacturing instructions.

In an embodiment of the invention, said system controller is configured to select said target footwear assembly from said different footwear assemblies by comparing said plurality of robot manufacturing instructions with said different series of footwear manufacturing instructions.

The footwear manufacturing robot system may be capable of selecting a target footwear assembly based on various input such as footwear assembly identification information or series of footwear manufacturing instructions, which is advantageous. Accordingly, the footwear manufacturing robot system may ensures that the automated footwear manufacturing robot operate on a footwear assembly which it is capable of handling, which is advantageous.

The footwear manufacturing robot system may be capable of handling several footwear assemblies, e.g. a first and a second footwear assembly, where each of the footwear assemblies have different series of footwear manufacturing instructions. This increases flexibility of the system, which is advantageous.

If two footwear assemblies are available for further manufacture, the system controller may then compare the plurality of robot manufacturing instructions the footwear manufacturing instructions of both footwear assemblies to select an elected manufacturing instruction. The automated footwear manufacturing robot may then proceed to manufacture one of the footwear assemblies, i.e. the target footwear assembly, based on the elected manufacturing instruction.

In an embodiment of the invention, said footwear manufacturing system further comprises a footwear instructions database communicatively coupled to said system controller.

In an embodiment of the invention, said footwear instructions database comprises said series of footwear manufacturing instructions.

In an embodiment of the invention, said footwear instructions database comprises said different series of footwear manufacturing instructions.

For example, each series of footwear manufacturing instructions is associated with a particular footwear assembly, a unique footwear assembly, and/or a footwear assembly relating to a particular size, model design, or type of footwear.

By having a footwear instructions database, any footwear manufacturing instructions may be rapidly available to the system controller, which is advantageous.

In an embodiment of the invention, said footwear assembly comprises at least one footwear part.

In an embodiment of the invention, said plurality of robot manufacturing instructions comprises unique robot manufacturing instructions for said at least two unique characteristics of said footwear property.

In an embodiment of the invention, said plurality of robot manufacturing instructions comprises unique robot manufacturing instructions for said at least two unique characteristics of said first footwear property and said at least two unique characteristics of said second footwear property.

In an embodiment of the invention, said plurality of robot manufacturing instructions comprises unique robot manufacturing instructions for said at least two unique characteristics of said first footwear property, said at least two unique characteristics of said second footwear property, and said at least two unique characteristics of said third footwear property.

By having unique robot manufacturing instructions for unique characteristics of several footwear properties, the footwear manufacturing robot system may be capable of rapidly at least partly manufacturing at least one of these footwear assemblies, which is advantageous.

In an embodiment of the invention, said series of footwear manufacturing instructions comprises attaching said footwear part to a jig.

In an embodiment of the invention, said plurality of robot manufacturing instructions comprises attaching said footwear part to a jig.

For different footwear assemblies, the attachment of a footwear part to a jig may require a different operations of an automated footwear manufacturing robot, such as different trajectories.

In an embodiment of the invention, said series of footwear manufacturing instructions comprises loading a frame with said footwear part.

In an embodiment of the invention, said series of footwear manufacturing instructions comprises de-loading said footwear part from said frame.

In an embodiment of the invention, said plurality of robot manufacturing instructions comprises loading a frame with said footwear part.

In an embodiment of the invention, said plurality of robot manufacturing instructions comprises de-loading said footwear part from said frame.

For different footwear assemblies, the loading/de-loading of a footwear part on a frame may require a different operations of an automated footwear manufacturing robot, such as different trajectories.

In an embodiment of the invention, said series of footwear manufacturing instructions comprises picking and placing said footwear part.

In an embodiment of the invention, said plurality of robot manufacturing instructions comprises picking and placing said footwear part.

For different footwear assemblies, picking and placing a footwear part may require a different operations of an automated footwear manufacturing robot, such as different trajectories. The footwear part may for example be placed on a second footwear part, or on frame, jig, last, or other vehicle of transportations and/or attachment.

In an embodiment of the invention, said series of footwear manufacturing instructions comprises stitching said footwear part.

In an embodiment of the invention, said plurality of robot manufacturing instructions comprises stitching said footwear part.

Stitching may for example be performed to fixate two footwear parts, e.g. a first and a second footwear part. Or stitching may be performed to stitch a footwear part to a fixture. Stitching may for example be 2D stitching or 3D stitching.

For different footwear assemblies, stitching may require different operations of an automated footwear manufacturing robot, such as different stitching patterns.

In an embodiment of the invention, said series of footwear manufacturing instructions comprises mould heating.

In an embodiment of the invention, said plurality of robot manufacturing instructions comprises mould heating.

Optimal mould temperature may for example vary for different footwear assemblies.

In an embodiment of the invention, said series of footwear manufacturing instructions comprises mounting a sole to an upper of said footwear assembly.

In an embodiment of the invention, said plurality of robot manufacturing instructions comprises mounting a sole to an upper of said footwear assembly.

In an embodiment of the invention, said series of footwear manufacturing instructions inserting said footwear part into a mould.

In an embodiment of the invention, said plurality of robot manufacturing instructions inserting said footwear part into a mould.

The insertion may potentially be prior to or after heating the mould. Potentially, several footwear parts may be inserted into the mould, such as a sole and an upper. The trajectory for inserting the footwear part may vary for different footwear assemblies.

In an embodiment of the invention, said series of footwear manufacturing instructions comprises injection moulding.

In an embodiment of the invention, said plurality of robot manufacturing instructions comprises injection moulding.

The amount of mould material may be different for different footwear assemblies.

In an embodiment of the invention, said series of footwear manufacturing instructions comprises cementing.

In an embodiment of the invention, said plurality of robot manufacturing instructions comprises cementing.

The cementing operation may vary for different footwear assemblies, e.g. amount of cementing material, pattern of applied cementing material, trajectory for applying the cemented material etc.

In an embodiment of the invention, said series of footwear manufacturing instructions comprises lasting an upper of said footwear assembly to a last.

In an embodiment of the invention, said plurality of robot manufacturing instructions comprises lasting an upper of said footwear assembly to a last.

In an embodiment of the invention, said series of footwear manufacturing instructions comprises de-lasting an upper of said footwear assembly from a last.

In an embodiment of the invention, said plurality of robot manufacturing instructions comprises de-lasting an upper of said footwear assembly from a last.

Lasting and de-lasting may require different robot operations for different footwear assemblies, such as different trajectories.

In an embodiment of the invention, said series of footwear manufacturing instructions comprises gluing two footwear parts of said footwear assembly together.

In an embodiment of the invention, said plurality of robot manufacturing instructions comprises gluing two footwear parts of said footwear assembly together.

In an embodiment of the invention, said series of footwear manufacturing instructions comprises adhering two footwear parts of said footwear assembly together.

In an embodiment of the invention, said plurality of robot manufacturing instructions comprises adhering two footwear parts of said footwear assembly together.

Glue and adhesion patterns may be different for different footwear assemblies.

In an embodiment of the invention, said series of footwear manufacturing instructions comprises heat pressing two footwear parts of said footwear assembly together.

In an embodiment of the invention, said plurality of robot manufacturing instructions comprises heat pressing two footwear parts of said footwear assembly together.

In an embodiment of the invention, said series of footwear manufacturing instructions comprises cold pressing two footwear parts of said footwear assembly together.

In an embodiment of the invention, said plurality of robot manufacturing instructions comprises cold pressing two footwear parts of said footwear assembly together.

Pressing duration and temperature may be different for different footwear assemblies.

In an embodiment of the invention, said series of footwear manufacturing instructions comprises cutting said footwear part.

In an embodiment of the invention, said plurality of robot manufacturing instructions comprises cutting said footwear part.

Cutting patterns and the resulting footwear parts may be different for different footwear assemblies. The cutting of a footwear part may produce a footwear part, or, alternatively, remove the footwear part from a jig/fixture.

In an embodiment of the invention, said series of footwear manufacturing instructions comprises brushing one or more footwear parts of said footwear assembly.

In an embodiment of the invention, said plurality of robot manufacturing instructions comprises brushing one or more footwear parts of said footwear assembly.

In an embodiment of the invention, said series of footwear manufacturing instructions comprises polishing one or more footwear parts of said footwear assembly.

In an embodiment of the invention, said plurality of robot manufacturing instructions comprises polishing one or more footwear parts of said footwear assembly.

In an embodiment of the invention, said series of footwear manufacturing instructions comprises grinding one or more footwear parts of said footwear assembly.

In an embodiment of the invention, said plurality of robot manufacturing instructions comprises grinding one or more footwear parts of said footwear assembly.

In an embodiment of the invention, said series of footwear manufacturing instructions comprises trimming said footwear assembly.

In an embodiment of the invention, said plurality of robot manufacturing instructions comprises trimming said footwear assembly.

Brushing, polishing, grinding, and trimming patterns/trajectories may be different for different footwear assemblies. Trimming a sole of the footwear assembly may improve finish after moulding.

In an embodiment of the invention, said series of footwear manufacturing instructions comprises lacing said footwear part.

In an embodiment of the invention, said plurality of robot manufacturing instructions comprises lacing said footwear part.

Lacing operations may be different for different footwear assemblies.

In an embodiment of the invention, said series of footwear manufacturing instructions comprises cleaning said footwear assembly.

In an embodiment of the invention, said plurality of robot manufacturing instructions comprises cleaning said footwear assembly.

A part of a footwear assembly may be cleaned prior to placing a footwear part onto it. E.g., a mould may be cleaned prior to placing a footwear part in the mould. The cleaning process may be different for different footwear assemblies.

In an embodiment of the invention, said series of footwear manufacturing instructions comprises quality controlling.

In an embodiment of the invention, said plurality of robot manufacturing instructions comprises quality controlling.

A quality control may for example involve machine vision, for example of the final footwear, or of the footwear assembly at an intermediate stage of manufacturing. The quality control may be different for different footwear assemblies.

Generally, a series of footwear manufacturing instructions may comprise any combination of specific manufacturing instructions (attaching, loading, de-loading, picking and placing, stitching, mould heating, mounting a sole, inserting, injection moulding, cementing, lasting, de-lasting, gluing, adhering, pressing, cutting, brushing, polishing, grinding, trimming, lacing, cleaning, quality controlling). Similarly, a plurality of robot manufacturing instructions may comprise any combination of specific manufacturing instructions. In various embodiments of the invention, the specific manufacturing instructions in the series of footwear manufacturing instructions are not necessarily the same as the specific manufacturing instructions in the plurality of robot manufacturing instructions. However, typically, at least one specific manufacturing instruction of the plurality of robot manufacturing instructions match a specific manufacturing instruction of the series of footwear manufacturing instructions. For example, the series of footwear manufacturing instructions may comprise all automated manufacturing instructions necessary for manufacturing the footwear, while the plurality of robot manufacturing instructions only comprise a single manufacturing instruction (e.g. stitching). In such a case, the robot manufacturing instructions may further relate to stitching of different model designs of footwear assemblies. I.e., the robot is capable of performing stitching operations on footwear assemblies relating to different model designs.

Since specific manufacturing instructions are different for different footwear, having such manufacturing instructions as a part of the footwear manufacturing instructions and/or robot manufacturing instructions may ensure correct production of different footwear, which is advantageous.

In an embodiment of the invention, said footwear manufacturing robot system further comprises an assembly proximity detector configured to obtain assembly proximity information.

In an embodiment of the invention, said robot controller is configured to execute said elected manufacturing instruction to operate said automated footwear manufacturing robot upon receiving said assembly proximity information.

Proximity detection may ensure that the automated footwear manufacturing robot has actually received a footwear assembly or the correct footwear assembly, which is advantageous.

The assembly proximity detector and the assembly identification receiver may optionally be a combined unit, e.g. where the assembly proximity information is also used to link the footwear assembly to its associated footwear assembly identification information. Thus, several functions may be performed in a single action, which is advantageous.

In an embodiment of the invention, said robot controller is communicatively connected to a local controller database configured to digitally store said elected manufacturing instruction as a consequence of said system controller selecting said elected manufacturing instruction.

In an embodiment of the invention, said robot controller executes said elected manufacturing instruction several times to operate said automated footwear manufacturing robot several times, while said elected manufacturing instruction is stored on said local controller database.

By having a local controller databased for digitally storing the elected manufacturing instruction, a slow transfer of the elected manufacturing instruction from the robot instructions database to the robot controller may be avoided, particularly of multiple assemblies require the same manufacturing, which is advantageous.

In an embodiment of the invention, said automated footwear manufacturing robot has a plurality of robot joints connecting a robot base to a robot tool flange for a robot tool.

In an embodiment of the invention, said automated footwear manufacturing robot is an automated mould heating machine.

In an embodiment of the invention, said automated footwear manufacturing robot is an automated injection moulding machine.

In an embodiment of the invention, said automated footwear manufacturing robot is an automated guided vehicle for transporting said footwear assembly.

In an embodiment of the invention, said automated footwear manufacturing robot is an automated parallel manipulator.

In an embodiment of the invention, said automated footwear manufacturing robot is an automated quality control machine.

In an embodiment of the invention, said plurality of robot manufacturing instructions is associated with at least two different robot tools.

In an embodiment of the invention, said system controller is further configured to select an elected robot tool of said at least two different robot tools, wherein said elected robot tool is associated with said elected manufacturing instruction.

In an embodiment of the invention, said elected manufacturing instruction is a first elected manufacturing instructions, wherein said system controller is further configured to select a second elected manufacturing instruction of said plurality of robot manufacturing instructions, wherein said robot controller is further configured to execute said second elected manufacturing instruction to operate said automated footwear manufacturing robot, wherein said first elected manufacturing instruction and said second elected manufacturing instruction are different.

In an embodiment of the invention, said first elected manufacturing instruction is associated with a first robot tool of said at least two different robot tools, wherein said second elected manufacturing instruction is associated with a second robot tool of said at least two different robot tools.

In an embodiment of the invention, said automated footwear manufacturing robot is configured to autonomously switch robot tools among said at least two different robot tools based said elected manufacturing instruction.

By having robot manufacturing instructions being associated with different tools, the flexibility of the robot system is increased, which is advantageous. an automated footwear manufacturing robot may for example both perform cutting with a cutting tool and stitching with a stitching tool.

In an embodiment of the invention, said at least two robot tools comprise one or more spray tools.

In an embodiment of the invention, said at least two robot tools comprise one or more clamping tools.

In an embodiment of the invention, said at least two robot tools comprise one or more vacuum gripping tools.

In an embodiment of the invention, said at least two robot tools comprise one or more polishing tools.

In an embodiment of the invention, said at least two robot tools comprise one or more cutting tools.

In an embodiment of the invention, said at least two robot tools comprise one or more stitching tools.

In an embodiment of the invention, said at least two robot tools comprise one or more grinding tools.

In an embodiment of the invention, said at least two robot tools comprise one or more brushing tools.

In an embodiment of the invention, said at least two robot tools comprise one or more trimming tools.

In an embodiment of the invention, said at least two robot tools comprise one or more roughing tools.

In an embodiment of the invention, said series of footwear manufacturing instructions are updated after completion of executing said elected manufacturing instruction to operate said automated footwear manufacturing robot.

The series of footwear manufacturing instructions may for example be updated by changing a footwear manufacturing instruction corresponding to the elected manufacturing instruction, e.g. removing or changing a status. Thus, the series of footwear manufacturing instructions may provide an improved indication of which manufacturing instructions remain to be executed.

In an embodiment of the invention, said footwear manufacturing instructions are related to an assembly manufacturing status, which is indicative of which of said series of footwear manufacturing instruction have already been executed.

In an embodiment of the invention, said assembly manufacturing status is updated after completion of executing said elected manufacturing instruction to operate said automated footwear manufacturing robot.

The assembly manufacturing status may be used to independently track the status of manufacturing of a given footwear assembly, which is advantageous. This status may for example be a separate digital entry in a database, independent of the series of footwear manufacturing instructions.

In an embodiment of the invention, said footwear manufacturing robot system comprises:
an auxiliary automated footwear manufacturing robot;
an auxiliary robot controller configured to control said auxiliary automated footwear manufacturing robot; and
   wherein said system controller is communicatively coupled to said auxiliary robot controller,
   wherein said plurality of robot manufacturing instructions comprises a first subset of robot manufacturing instructions and a second subset of robot manufacturing instructions,
   wherein said first subset of robot manufacturing instructions are for said robot controller and said second subset of robot manufacturing instructions for said auxiliary robot controller,
   wherein said auxiliary automated footwear manufacturing robot is configured to manufacture said different footwear assemblies at least partially.

In an embodiment of the invention, said elected manufacturing instruction is of said first subset of robot manufacturing instructions.

In an embodiment of the invention, said system controller is further configured to select an auxiliary elected manufacturing instruction of said second subset of robot manufacturing instructions,

wherein said auxiliary robot controller is configured to automatically execute said auxiliary elected manufacturing instruction to operate said auxiliary automated footwear manufacturing robot.

In an embodiment of the invention, said elected manufacturing instruction and said auxiliary elected manufacturing instruction are different.

In an embodiment of the invention, said automated footwear manufacturing robot and said auxiliary automated footwear manufacturing robot are different.

Some embodiments thus comprise two automated footwear manufacturing robots (non-auxiliary and auxiliary), which may for example perform different tasks, which may advantageously improve flexibility and work pace of the system.

If two different automated footwear manufacturing robots and their respective controllers have different subsets of robot manufacturing instructions, the system controller may select an elected manufacturing instruction of one of the two subsets, such that the robot associated with that subset may operate to manufacture the footwear accordingly. That robot may then be understood as then the (non-auxiliary) automated footwear manufacturing robot, while the other robot may be understood as the auxiliary automated footwear manufacturing robot.

In an embodiment of the invention the footwear assembly identification information is unique.

In an embodiment of the invention said footwear assembly identification information is unique and associated to a footwear record FREC stored in a footwear record database FRECDB, the record including data defining at least model design and size of the associated footwear assembly.

In an embodiment of the invention said database stores a plurality of footwear records FREC each being defined by a unique associated footwear assembly identification information and each record including data defining at least model design and size of the associated footwear assembly, and wherein the data defining at least model defines one out of a plurality of model designs, and where the data defining size defines one out of a plurality of sizes.

In an embodiment of the invention said system controller and/or said robot controller is communicatively coupled with said footwear record database FRECDB.

In an embodiment of the invention said data defining model design is associated with respective robot manufacturing instructions.

In an embodiment of the invention said data defining size is associated with respective robot manufacturing instructions.

An aspect of the invention relates to method for at least partially manufacturing footwear assemblies, said method comprising the steps of:
providing a plurality of robot manufacturing instructions to a robot instructions database;
selecting an elected manufacturing instruction of said plurality of robot manufacturing instructions based on footwear assembly identification information associated with different footwear assemblies;
automatically executing said elected manufacturing instruction on a robot controller configured to control an automated footwear manufacturing robot to operate said automated footwear manufacturing robot.

In an embodiment of the invention, said step of selecting an elected manufacturing instruction is performed by a system controller communicatively coupled to said robot instructions database.

In an embodiment of the invention, said automated footwear manufacturing robot is configured to manufacture said different footwear assemblies at least partially.

In an embodiment of the invention, said automated footwear manufacturing robot, said robot controller, said robot instructions database, and said system controller form a footwear manufacturing robot system according to any of the disclosed footwear manufacturing robot systems.

In an embodiment of the invention, said step of automatically executing said elected manufacturing instruction comprises at least partially manufacturing a footwear assembly of said different footwear assemblies.

The footwear assembly being at least partially manufactured may for example be the target footwear assembly.

In an embodiment of the invention, said elected manufacturing instruction is partially pre-programmed prior to said step of selecting said elected manufacturing instruction.

In an embodiment of the invention, said elected manufacturing instruction is fully pre-programmed prior to said step of selecting said elected manufacturing instruction.

In an embodiment of the invention, said plurality of robot manufacturing instructions comprises at least two partially pre-programmed manufacturing instructions.

In an embodiment of the invention, said plurality of robot manufacturing instructions comprises at least two fully pre-programmed manufacturing instructions.

Fully and partially pre-programmed manufacturing instructions may improve efficiency, which is advantageous.

In an embodiment of the invention, said method further comprises a step of automatically programming a part of said elected manufacturing instruction after said step of selecting said elected manufacturing instruction.

In an embodiment of the invention, said step of automatically programming said part of said elected manufacturing instruction is based on said footwear property.

The automatic programming may for example be based on a footwear property, such as model design, footwear size, footwear colour, footwear material, model type, footwear type, and footwear assembly ID.

In the present context, elected manufacturing instructions may imply that code fragments are selected and executed by the robot controller from a plurality of possible robot manufacturing instructions. This makes it possible in principle to make the robot able to process a specified footwear assembly with any type of process or process step the robot is able to physically perform.

It should be noted that selection of manufacturing instructions alternatively may be established e.g. by so-called off-line programming, enabling that the robot may switch between operations matching the requirements related to the current process step to be performed on a specific footwear assembly by keeping code fragments on the robot controller fixed, i.e. not modifying the programming code, but simply changing one or more of the process parameters. In this way, the communication between the robot controller and system controller in a larger system may be kept relatively low.

The election of another set of elected manufacturing instructions may thus simply be obtained by changing the parameters and thereby providing a number of coordinates reflecting the elected manufacturing instructions. Elected manufacturing instructions may thus also be understood as selected code fragments or as modified code or it may e.g. be understood as coordinates provided to or at the manufacturing robot enabling the robot controller executing the intended operation. An alternative to this rationale may be to associate the footwear assembly initially with the code instructions and transfer these instructions with the footwear assembly for the footwear manufacturing robot to read and execute.

The assembly identification information may advantageously be unique, thereby not only facilitating a tracking of the assembly as such throughout the manufacturing process or at least a part of the manufacturing process. It also facilitates a logging of the specific assembly specifying what has already been done in relation to the assembly identified by the unique footwear assembly identification information and thereby also facilitates that the assembly is handled efficiency later on during the remaining manufacturing process. In other words: By providing a unique assembly identification information, it will be possible for the following footwear manufacturing robot(s) to select the proper manufacturing instructions. This is assisted by the unique ID as a log may be kept centrally of de-centrally (somewhere in the system) which is available to the footwear manufacturing robot, thereby ensuring that the right manufacturing instructions are performed.

In other words, operating the robot on the basis of a unique identification information related to the footwear assembly, facilitates that a robot may perform many different types of tasks/instructions.

### THE DRAWINGS

Various embodiments of the invention will in the following be described with reference to the drawings where

FIG. 1 illustrates schematically a footwear manufacturing robot system according to an embodiment of the invention,

FIG. 2 illustrates schematically a footwear manufacturing robot system according to another embodiment of the invention,

FIG. 3 illustrates schematically a footwear manufacturing robot system according to an embodiment of the invention with two automated footwear manufacturing robots,

FIG. 4 illustrates a block diagram of selection of an elected manufacturing instruction based on a comparison with different series of footwear manufacturing instructions according to an embodiment of the invention,

FIG. 5 illustrates a block diagram of selection of an elected manufacturing instruction based on a comparison with a plurality of robot manufacturing instructions relating to unique footwear sizes according to an embodiment of the invention,

FIG. 6 illustrates method steps according to an embodiment of the invention,

FIG. 7 illustrates abstract representations of robot manufacturing instructions, footwear manufacturing instructions, and elected manufacturing instructions according to an embodiment of the invention,

FIG. 8A-D illustrates a footwear manufacturing line within the scope of the invention

FIG. 9 illustrates a routed embodiment of a footwear manufacturing line within the scope of the invention,

FIG. 10 illustrates a further routed embodiment of a footwear manufacturing line within the scope of the invention,

FIG. 11 illustrates a further routed embodiment of a footwear manufacturing line within the scope of the invention where the manufacturing line is implemented in manufacturing stages, and where

FIG. 12 illustrates a further feature of and advantageous embodiment of the invention.

### DETAILED DESCRIPTION

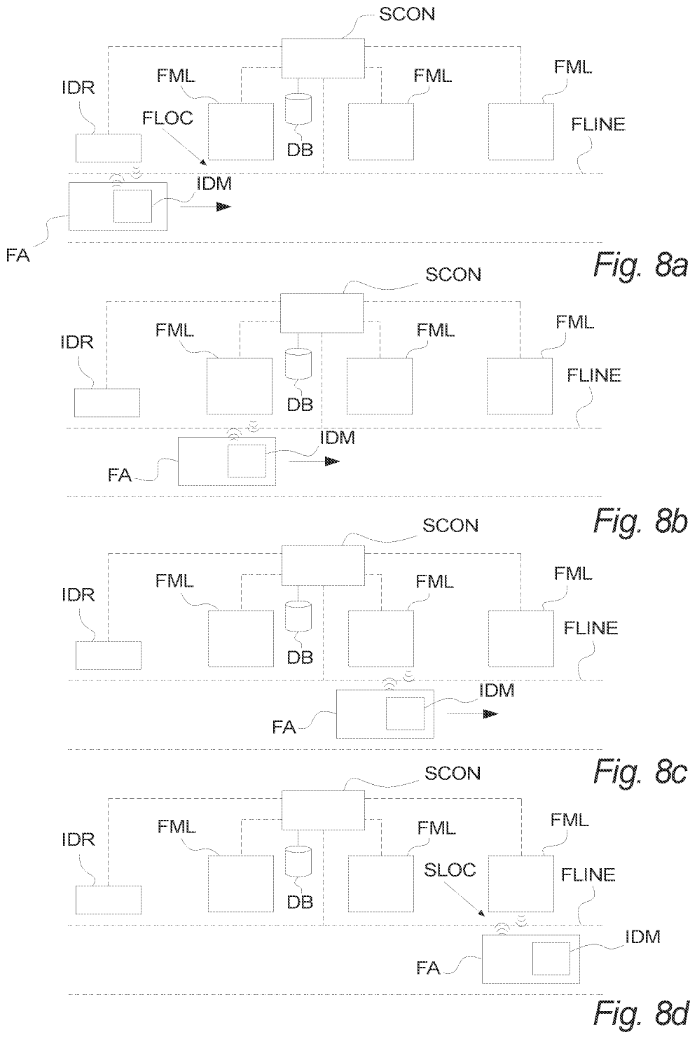

FIG. 8A illustrates an exemplary way of routing a footwear assembly FA though a footwear manufacturing line FLINE according to an embodiment of the invention.

A “footwear assembly” within the context of the present invention is understood broadly at a gathering of a number of footwear parts at any time during manufacture of a footwear from the time initial footwear parts has been gathered or prepared, even before mutual attachment of the gathered footwear parts, e.g. by stitching until a final footwear has been mounted with a sole and footwear has been finished and ready for packaging. In other words, when a footwear assembly proceeds during a manufacturing process, components and features may be accumulated into the footwear assembly and the footwear assembly be further processed.

It is noted that the footwear assembly in a preferred embodiment of the invention is uniquely defined/identified across not only sizes or variants of a footwear model but also across footwear models.

In other words, the ID—or in practice the associated identification representation—may be applied for a combined setting the programs of the respective footwear manufacturing robot and also an automatic routing of the footwear further along the manufacturing process of the footwear manufacturing line FLINE.

A “footwear manufacturing line” is in the present context not only designating a conventional footwear inline assembly line, but also a branched footwear assembly line, where the individual footwear assemblies may be routed individually between different footwear manufacturing robots, including footwear robots performing the same task across different models. It is also noted that the term “footwear manufacturing line” broadly designates a technical measure capable of transporting a specified footwear assembly from one footwear manufacturing robot location to another footwear manufacturing robot on another location. As long as such transport is carried out according to the provisions of the invention, transport measures may include conveyer, mobile carriages, drones, etc, as long as the footwear individual footwear assemblies are transported to the relevant and necessary footwear manufacturing robots at their respective locations in the right order. Broadly such technical measured will be referred to as carriers unless otherwise noted.

It should generally be understood according to an embodiment of the invention that the term routing will indicate that the footwear assembly's transportation path from the start/input to the final output is not given just by e.g. size and model. This means in practice that a certain footwear assembly, which according to its design is going to end up as a footwear of e.g. a certain size and as a certain model may now be associated with design information, size information, etc so that a (unique) identification representation stored in a database accessible for the system controller and thereby facilitating that the system controller can lead the footwear assemblies to and through the required manufacturing steps (elsewhere referred to as “instructions”)—but also in the right order.

In the illustrated footwear manufacturing line FLINE, a footwear assembly FA is transported under the control of a system controller SCON communicating with a database DB. In the illustrated embodiment a footwear manufacturing robot (not shown) is located at a number of footwear manufacturing locations FML, in the present exemplary embodiment there are three manufacturing locations. Higher numbers of footwear manufacturing locations may be applied within the scope of the invention depending on how large capacity the footwear manufacturing line need to have.

The database contains information, e.g. a number of unique records, each designating a footwear assembly and essentially designating a final footwear to be produced. The records should include footwear identification representation designating each footwear assembly and preferably also a number of attributes including e.g. model, model characteristics, size, etc.

The presently illustrated footwear assemble FA is shown as being transported from a first location FLOC to a second location SLOC via a number of footwear manufacturing locations FML. In the present embodiment, the number of footwear manufacturing locations FML is essentially just one for reasons of simplicity, e.g. the footwear manufacturing location FML between the first location FLOC and the second location SLOC.

The illustrated footwear assembly FA is initially scanned in FIG. 8A by a identity reader IDR reading an identity marking IDM. The identity marking may e.g. be fixedly attached to a part of the footwear assembly, in particular to the upper of a footwear assembly. The identity may either be confirmed of established during scanning and the footwear assembly identity representation is communicated the communicatively coupled system controller thereby informing the system controller SCON that a footwear assembly is ready for transport to the first location.

In FIG. 8B, the footwear assembly has now arrived to the first location FLOC where a footwear manufacturing robot (not shown) is performing a manufacturing step according to a footwear manufacturing instruction. In the present context, such instruction could be stitching of footwear parts of a footwear assembly into a footwear assembly comprising an upper. The stitching task is performed specifically according to what is required based on the registered identification footwear representation and what is contained and defined in the database of the system controller and/or the footwear manufacturing robot FMR (not shown). In other words, the operation performed at the footwear manufacturing location, the first location FLOC, is performed and triggered on the basis of the read unique ID by reading the identity marking.

Subsequently, again based in the read ID marking, the system controlled initiated transportation of the footwear assembly FA to another footwear manufacturing robot FMR is illustrated in FIG. 8C, where a footwear manufacturing robot (not shown) is performing a manufacturing step according to a footwear manufacturing instruction. In the present context, such instruction could be an automatic lasting of the previously manufactured upper onto a last. In FIG. 8C, the ID marking attached to the footwear assembly is not read, but the system controller determines the unique identity e.g. by deducing the location of the footwear assembly by knowing the transport time from the last know location of FIG. 8B. Numerous different methods of correlating the correct identity of the footwear assembly FA may be applied within the scope of the invention as long as the exact identity of the footwear assembly cannot be mistaken.

The known identity of the footwear assembly at the footwear manufacturing location FML of FIG. 8C is then applied as an automatic measure for transporting the footwear assembly to the second location SLOC, the footwear manufacturing location FML.

In FIG. 8D, at the second location SLOC, the identity is then determined by reading an identity marking associated but not fixedly attached to the footwear assembly. The identity marking may e.g. be carried by the last and actually be a unique ID, uniquely identifying the last to the system controller and paired to the identity of the footwear assembly in FIG. 8D, thereby facilitating a unique identification of the footwear assembly, again without directly at the spot, reading the identity marking attached to the footwear assembly FA.

The point of the above explanation is to illustrate that the identity of a footwear assembly may be monitored in many different ways throughout the footwear manufacturing process directly at the different manufacturing locations, but also that is possible, and sometimes even advantageous, to establish the identification representation of the footwear assembly by supplementary methods as long as the system controller can unambiguously control the transport of the footwear assembly between the footwear manufacturing locations FML and at the same time ensure the proper manufacturing steps are made at the footwear manufacturing locations.

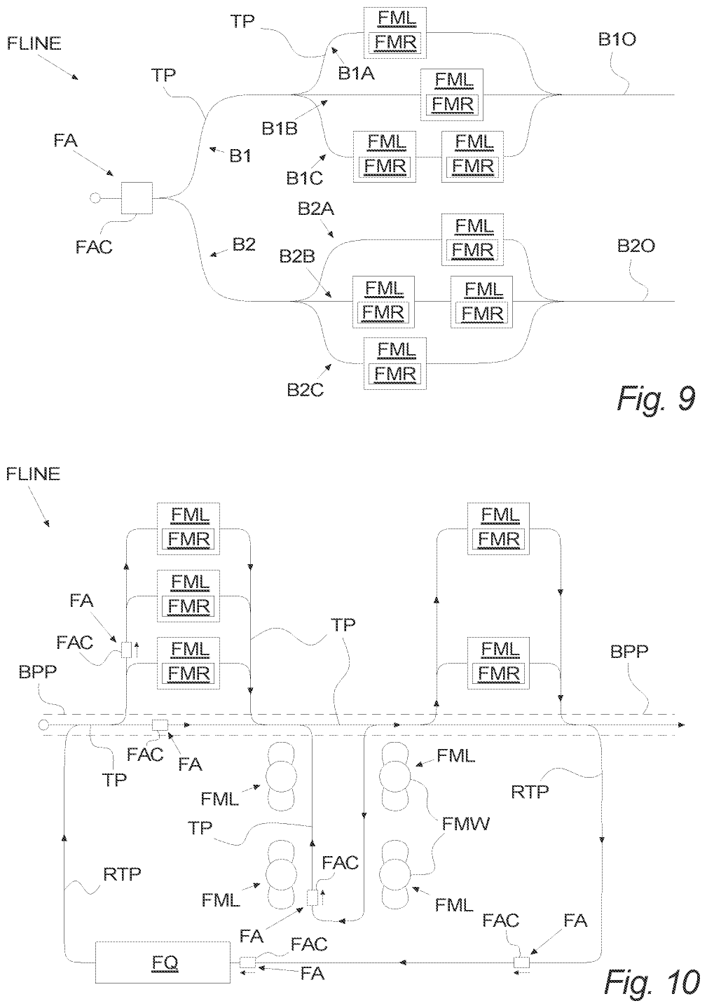

It should be noted in relation to FIG. 8A-D and also the below FIGS. 9 to 11, there the identity representation of the individual footwear assemblies are monitored directly or indirectly throughout the manufacturing line, thereby availing the system controller to invoke a switching of the configuration of a footwear manufacturing robot, i.e. switching between variants of a process step (e.g. stitching or polishing) before a footwear assembly arrives to a footwear manufacturing robot, thereby minimizing idle time of the footwear manufacturing robot and footwear assembly.

Moreover, it should be noted that the system controller is furthermore able to route footwear assemblies to both optimize the use of all available footwear manufacturing robots, but also minimize the automatic switching between variants of footwear manufacturing instruction(s) at the respective footwear manufacturing robots.

FIG. 9 illustrates a further embodiment of the invention.

The illustrated embodiment shows a footwear manufacturing line FLINE having a transportation path TP which is branched into two branches of transportations paths, B1 and B2 and then, each again into three further transportation paths B1A, B1B, B1C and B2A, B2B, B2C, respectively.

A system controller (not shown) is configured for routing a plurality of footwear assemblies FA on footwear carriers FAC. Although many carriers (and respective footwear assemblies) may be deployed, only one is shown in the present illustration in order to illustrated the functionality easier. It should be noted that the identity of each footwear assembly FA must be monitored throughout the illustrated system, e.g. as illustrated in FIG. 8A-8D, when routed through the transportation path under control by the system controller. It should also be noted that the illustrated system may only illustrate a part of a footwear manufacturing line FLINE. The system may be expanded to include the desired/required footwear manufacturing robots FMR provided that the system controller can monitor and control the routing between the footwear manufacturing robots FMR at their footwear manufacturing locations FML and that the required processing steps of each footwear model to be produced is available via a configurable transportation path.

The illustrated branching may thus bring the footwear assembly carrier FAC from a footwear manufacturing line input FLINI to two footwear manufacturing line outputs FLINO under the control of the system controller.

The system controller may thus control both:
Which footwear manufacturing robots FMR (the one(s) on one of the transport paths B1A, B1B, B1C, B2A, B2B, B2C, and
The setting of the specific footwear manufacturing instruction at the selected footwear manufacturing robots FMR needed to obtain the desired processing of the specific footwear assembly.

The setting may be controlled directly by central control by the system controller of the footwear manufacturing robot in question when the footwear assembly arrives and are ready for processing.

The setting may also be controlled by the central control by the system controller of the footwear manufacturing robot in question by locally storage/programming of the different possible variants of the footwear manufacturing instruction at the footwear manufacturing robots and then letting the routing combined with the established identity of the footwear assembly at the “routed-to” footwear manufacturing robots determine which variant of an instruction is to be executed.

FIG. 10 illustrates a further advantageous embodiment of the invention, showing a footwear manufacturing line FLINE comprising a number of footwear manufacturing robots FMR at respective footwear manufacturing locations FML. The footwear manufacturing line includes a number of branched transportation paths TP and footwear assemblies carriers FAC may carry footwear assemblies FA along the transportation paths and the routing may, as in the above embodiment, be controlled by a system controller (not shown).

Again, the illustrated footwear manufacturing robots, as in the above illustrated embodiments, may be configured automatically upon or just before arrival of the footwear assembly to the footwear manufacturing robots, again facilitating a combined routing and dynamic re-configuration of the footwear manufacturing robots FMR, thereby making it possible to produce different models of a footwear on one manufacturing line at the same time, and dynamically even switch between manufacturing of one model solely and then another model solely, and in between produce both models at the same time. The routing and the dynamic possibility of reconfiguring the footwear manufacturing robots makes it possible to have an extremely high load on the manufacturing line and also to ensure that manufacturing robots are kept busy, dynamically.

The branching/routing controlled by the system controller further allows the system controller to bypass a footwear manufacturing robot requirement maintenance and adapt the manufacturing to the intended production.

A further feature of the present invention is the transportation path by design includes at bypass path BPP (formed by a part of the transportation path TP) by means of which a footwear assembly may be sent to bypass the shown footwear manufacturing robots if they are busy or not configured the planned process step (e.g. a trimming instruction) or an intended variant of the trimming instruction. The footwear assembly may then be transported, under control by the system controller to further footwear manufacturing robots down the line (not shown) fit for the purpose as is or when reconfigured.

It is furthermore possible to return a non-processed footwear assembly back in the system by a return transportation path RTP and even form a que FQ until it is routed back to the now available footwear manufacturing robots. The point is that the bypass path BPP makes it possible to route past busy footwear manufacturing robots and back into the system via the return transportation path RTP, and in a possible que, without making obstacles and blocking the manufacturing line.

Furthermore the illustrated manufacturing line is designed with a breakout transportation path to footwear manufacturing locations FML operated manually by workers FMW. Such an operation would still be supervised by the system controller and the individual footwear assemblies FA may be individually routed this breakout line, e.g. for quality inspection, manual operations, etc.

It should also be noted that the manufacturing line may be separated in different groups, each group carrying our different stages of the manufacturing. Different types of transportation may also be applied to transfer footwear assemblies between such footwear manufacturing stages.

An interesting and attractive feature of the footwear manufacturing line of e.g. FIGS. 9, 10 and 11 is that a footwear assembly (carried by a carrier) may overtake other footwear assemblies (carried by other carriers).

In other words, specified footwear assemblies, footwear models, etc may be given priority in the manufacturing line within the scope of the invention.

A further interesting and attractive feature of the footwear manufacturing line of e.g. FIGS. 9, 10 and 11 is that a footwear assemblies may be monitored dynamically to adjust the routing throughout the complete manufacturing line if so desired. Footwear assembly “traffic jam” may thus be dealt with by re-routing footwear assemblies to other available footwear manufacturing robots capable of performing the required process step(s).

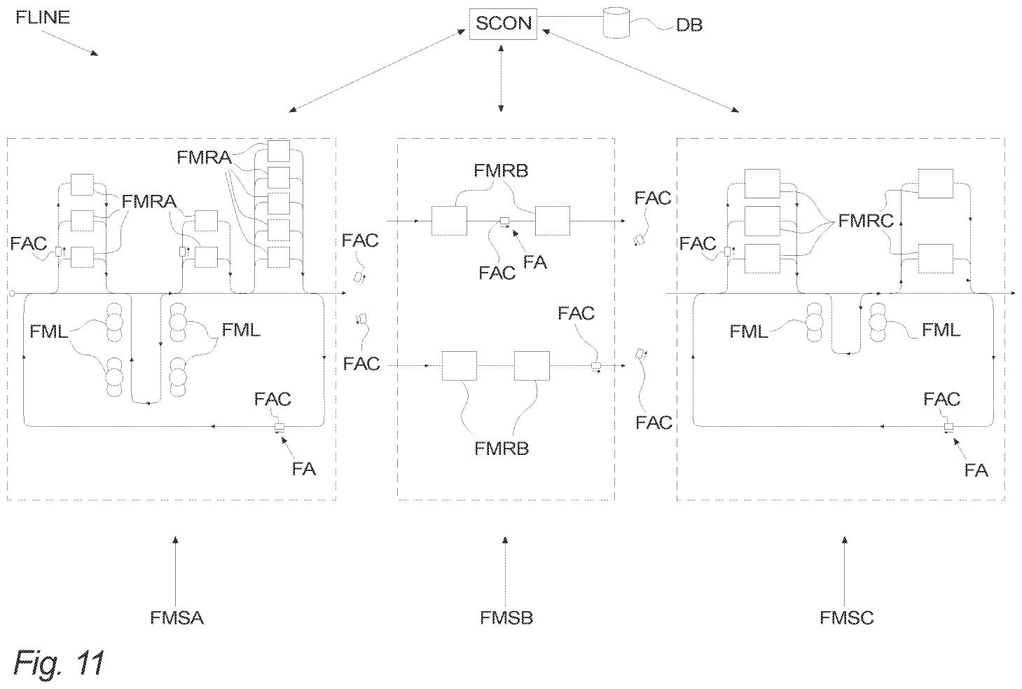

FIG. 11 illustrates such a division of the manufacturing line into stages.

The exemplary illustrated footwear manufacturing line FLINE comprises three footwear manufacturing stages FMSA, FMSB and FMSC. The three footwear manufacturing stages FMSA, FMSB and FMSC respectively includes footwear manufacturing robots FMRA, FMRB and FMRC.

The system controller is communicatively coupled with the footwear manufacturing robots FMRA, FMRB and FMRC and is also communicatively coupled for control of footwear assembly carriers FAC moving footwear assemblies from one footwear manufacturing robot to another in order to establish and provide the process steps defined by the respective series of footwear manufacturing instructions of each respective footwear assembly FA. Only a few of the relatively hight amount of footwear assembly carries (each carrying respective footwear assemblies) are shown for reasons of simplicity.

The first footwear manufacturing stage FMSA may e.g. include the process steps stacking, stitching and lasting, i.e. providing a stacking footwear manufacturing instruction, a stitching footwear manufacturing instruction for providing an upper and a lasting a footwear manufacturing instruction. The first footwear manufacturing stage also includes a footwear manufacturing location FML configured for a manual process step, e.g. quality control and it is also monitored by the system controller SCON. Groups or individual footwear assemblies may be carried by footwear assembly carriers from the first footwear manufacturing stage FMSA to the second footwear manufacturing stage FMSB.

The second footwear manufacturing stage FMSB may be fed with lasted uppers under control by the system controller SCON. The first process step may be performed by preparing molds for injection molding onto the uppers and the second process step may e.g. include the injection molding of a sole onto the upper as such.

Groups or individual footwear assemblies may be carried by footwear assembly carriers from the second footwear manufacturing stage FMSB to the second footwear manufacturing stage FMSC.

The third footwear manufacturing stage FMSC may be configured for different process steps required for finalizing the footwear, such steps includes removal of molds, trimming of the sole, polishing of the uppers, lacing, de-lasting, etc.

In real life the illustrated footwear manufacturing stages FMSA, FMSB and FMSC may include different series of process step/footwear manufacturing instructions. The overall intention of the illustrated footwear manufacturing stages is to make it clear to the skilled person that different process steps may be grouped in different stages.

As mentioned elsewhere in the present application, the transportation between footwear manufacturing robots and footwear manufacturing locations and footwear manufacturing stages may be carried out in several different ways within the scope of the invention.

As long as such transport is carried out according to the provisions of the invention, transport measures may include conveyer, mobile carriages, drones, etc, as long as the footwear individual footwear assemblies are transported to the relevant and necessary footwear manufacturing robots at their respective locations in the right order. Broadly such technical measured will be referred to as carriers unless otherwise noted. It is also noted that a footwear manufacturing line within the scope of the invention may include different types of transportation and combinations of different types of transportation.

In the illustrated three footwear manufacturing stages FMSA, FMSB and FMSC, FMSA and FMSC may e.g. be implemented by electromagnetically driven carriages and the carriers in FMSB may e.g. be implemented by a walking beam.

A technical way of implementing the embodiments or parts of the embodiments of FIG. 8A-D to FIG. 11 may be e.g. be described in WO2015042409A1.

WO2015042409A1 thus discloses a mechanical structure of a transportation path which may be applied to implement the transportation between footwear manufacturing locations within the scope of the invention.

EP3501880, “Linear drive system having central, distributed and group control.” discloses an example a linear drive system which may be controlled and applied according to the provision of the present invention. In this document, carriers are referred to as movers. It is also noted that this document refers to segment controllers mutually communicating with a central controller. In the present context, such controllers would broadly be designated as the system controller, thus implying the system controller of the present invention may be distributed.

EP1907257, “Guideway activated magnetic switching of vehicles”, illustrates technical measured for obtaining a switching between different branches, an example of routing within the scope of the present invention.

EP1277186, “Passive position-sensing and communications for vehicles on a pathway”, illustrates one way of sensing the position of the carriers on a transportation patch which may be applied within the scope of the invention.

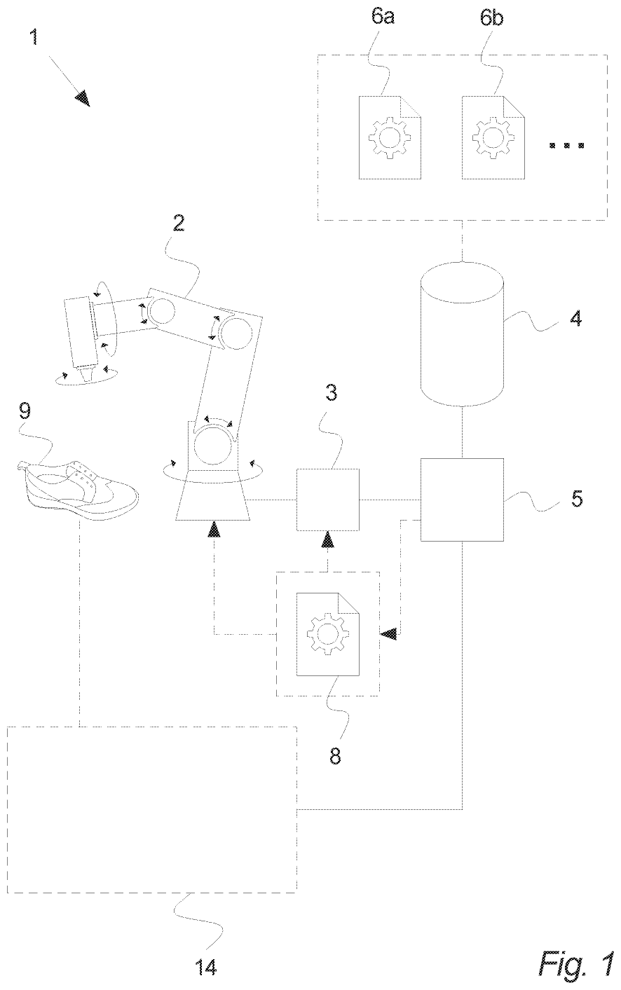

Footwear manufacturing robots as referred to in relation to FIGS. 1 to 4 may be regarded as a robots configured for performed a certain process step. A process step is also in the present application referred to as a footwear manufacturing instruction.

Different types of types of robots which may be applied in a system within the scope of the invention are described below. Preferably these robots, the footwear manufacturing robots, should be implemented to perform different variants of a footwear manufacturing instruction for the purpose of covering the same process step for different models with the same footwear manufacturing robot, and preferably a shifting between such different variants of a footwear manufacturing instruction should be carried out dynamically, dynamically based on what model is routed to the footwear manufacturing robot.

An example of a of a footwear manufacturing robot which may be adapted for work within the scope of the invention is described WO 2020/173532 A2 (published 3 Sep. 2020) and titled “Method of manufacturing a footwear”. The document relates to a method whereby a leather base layer and a leather attachment layer are provided, whereby the leather base layer and the leather attachment layer are fixed against each other with an intermediate application of adhesive between them and integrated as part of a footwear. Steps of the manufacturing may be automated, e.g. in an automated manufacturing robot line, using an automatic stacking arrangement, an automatic adhesive arrangement and an automatic curing arrangement.

Furthermore, an automatic footwear processing arrangement is disclosed, which has an input and an output, wherein the method of providing the leather base layer and the leather attachment layer is performed in an automatic process transporting the leather base layer and the leather attachment layer from the input and stacking these, one layer at least partially overlapping the other layer and wherein the activation is performed automatically by means of an automatic adhesive activation arrangement and wherein the process of forcing the leather base layer and the leather attachment layer against each other under a pressure P with the adhesive between them is performed by an automatic pressure activation arrangement.

It is noted that an automatic arrangement in the context of the cited international application is e.g. referring to a unit or a number of automatically operated units working automatically at least between an input and an output of the arrangement. The transfer to the input(s) and from the output(s) may thus be implemented as manual, semi-automatic or automatic processes.

An further example of a of a footwear manufacturing robot which may be adapted for work within the scope of the invention is described International patent application no. PCT/DK2020/050386 titled “Automatic stitching of footwear parts” (filed 18 Dec. 2020, priority date 20 Dec. 2019). The document discloses that in connection with manufacturing of footwear, e.g. footwear being assembled of at least two footwear parts, an identifier may be provided for identifying a fixture, a base layer or at least one of the footwear parts. Hereby, the identity of an actual piece of footwear being made may be identified along a manufacturing line by use of a control system and the control system may perform the appropriate next step in the manufacturing.

Hence, the identity of the actual piece of footwear being manufactured may be known, e.g. whether it is the fixture, the base layer or at least one of the footwear parts that are proceeding along the manufacturing line that is identified. Thus, when proceeding along the manufacturing line and through the processing steps, the control system may read the identity and perform the correct next step to be performed. Thus, it may for example be possible that the control system, when identifying the actual fixture, the actual base layer and/or an actual footwear part, may know that it is left hand shoe being made in size 39 with a specific colour and that the next step is addition of a facing. The control system may thus retrieve such a shoe part and place it in the correct position, where after the fixture may be conveyed further on for fixation of the facing and subsequent automated stitching of the facing to the assembly. Hence, it will be understood that due to the identifier, the actual footwear being made may be understood as effectively controlling the manufacturing and processing steps, e.g. being the actual controller itself, in that the specific steps being performed will depend on the actual identity of the footwear being manufactured. The identifiers used may be RFID devices or similar electronic devices.

An further example of a of a footwear manufacturing robot which may be adapted for work within the scope of the invention is described in International patent application no. PCT/DK2020/050245 titled “Automated footwear manufacturing line and method of operating such manufacturing line” (filed 3 Sep. 2020, priority date 26 Feb. 2020)). The document relates to a method of manufacturing at least a part of a footwear in an automatic manufacturing line, e.g. including at least one automated further step of automatically stacking, automatically activating or curing a further leather attachment layer onto a leather base layer and a leather attachment layer already bonded to each other.

The automatic manufacturing line according to the cited international application is applied for the purpose of implementing a plurality of manufacturing sequences, each manufacturing sequence including the process of assembling footwear parts into a final footwear item or at least an intermediate footwear product including at least a part of a footwear upper preferably including at least a vamp and/or a quarter attached with at least a further footwear upper part.

It is noted that the automatic manufacturing line includes at least one processing unit and a communication network controlling the operation of an automated stacking arrangement, e.g. a pick and place device in the form of a robot, the operation of activating the applied adhesive and automatically forcing the layers together during at least a part of the curing phase. Moreover, it may be set up as an automatic process that is adapted to automatically ensure that optionally required cooling, passively or actively provided, is controlled to ensure that the relevant layers are mutually attached and cured enough to safely pass them on into a next step/station of the manufacturing process. This next step may e.g. be automatic or manual stitching of the bonded footwear parts into a 3D upper, a subsequent automatic cementing or DIP process for the purpose of gathering/attaching the footwear upper to a sole, a subsequent cutting of superfluous sole material, automatic polishing of the footwear, etc.

In the cited International patent application it is noted that a robot may for example be a robot arm, an articulated robot, a SCARA robot, a delta robot and a cartesian coordinate robot, but that the robots are not restricted to a particular type, and that a skilled person may select any type of robot for a given part of a production line that skilled person finds suitable. As disclosed, a robot may for example be programmed to repetitively carry out specific actions over and over with a high degree of accuracy, for example relying on exact placement of footwear parts. A robot may also rely on e.g. a visual detection system VDS to locate footwear parts and perform a required operation. A robot may for example be a six-axis robot arm, which allows the robot tool to be moved at any angle to any location within the limitations of the robot arm.

The disclosed robot arm may be attached to a robot gripperI, which allows it to pick up and place items such as footwear parts, such as leather base layers and leather attachment layers. Such a robot tool may for example be a part of a pick-and-place device or an automatic stacking arrangement. Another robot tool may be a robot stitching tool, for example be used to stitch footwear parts together, for example 2D footwear parts or 3D footwear parts, for example as a supplement to adhesive. Another robot tool may be a robot adhesive appliance tool, which may be used to apply adhesive. Another robot tool may be a robot vacuum gripper, which may be used to pick up and place items such as footwear parts. In other embodiments, a robot tool may for example be used to force the leather base layer and the leather attachment layer against each other under a pressure, to activate the adhesive, to cool or cure the adhesive etc.

An further example of a of a footwear manufacturing robot which may be adapted for work within the scope of the invention is described Danish patent application no. DK PA 2020 70841 titled “A mould device for direct injection moulding of footwear, a system comprising such a mould device and a direct injection moulding system” (filed 16 Dec. 2020). The document relates to direct injection moulding system for manufacturing of footwear, which system is configured for conveying at least one mould device from one station to a subsequent station out of a plurality of stations and wherein direct injection moulding manufacturing of footwear may be enabled in an automated manner, e.g. by one or more of the stations comprising equipment to provide the required handling of the mould device, injection of injection material, etc.

The mould device may comprise an identifier, e.g. an RFID device, which identifier is associated with one or more parts of the mould device. Thereby, it may be achieved that the mould device, which may be moved, transported conveyed, stored, etc, for example when it is containing a moulded footwear part that for example is within a curing process, may be identified, tracked, etc, by use of said identifier. Furthermore, it is noted that said identifier may furthermore serve for facilitating retrieval of data relating to a possible moulded footwear part that may be contained within the mould device. Even further, it is noted that the mould device may comprise more than one identifier, e.g. one for the side mould(s), one for the bottom mould, etc. and that a last may also comprise an identifier, such that these parts may be identified on their own, e.g. in case that they are being transported, processed, prepared, etc. in separate flows and combined for a moulding process at a later stage. Also, it is noted that an identifier may comprise e.g. circuit(s) relevant for information related to the mould device.

The below FIGS. 1-7 illustrates different ways of implementing a footwear manufacturing in a system within the scope of the invention and different variants of footwear manufacturing robots which may be applied according to the provisions of the invention.

FIG. 1 illustrates schematically a footwear manufacturing robot system 1 according to an embodiment of the invention.

This particular embodiment has an automated footwear manufacturing robot 2 configured to perform trimming of footwear assembly after mounting the upper of a footwear assembly to the sole of that footwear assembly via direct injection moulding. Such a moulding process may leave a ridge in the moulded material around the perimeter of the shoe due to an imperfect fit of the mould parts. An automated footwear manufacturing robot 2 with a robot tool (not shown) in the form of a trimming, cutting, deburring, or polishing tool may then apply its robot tool to remove or smoothen this ridge.

The exemplary robot 2 has a plurality of robot joints connecting a robot base to the robot tool. Each of the joints are rotatable, such that the position and the orientation of the robot tool can be freely adjusted within the constraints of the robot 2. The joints, and thus the position and orientation of the robot tool, are controlled by a robot controller 3. In this particular embodiment, the robot controller 3 further controls the robot tool, but note that in other embodiments, the robot tool is not controlled by the robot controller.

A robot instructions database 4 has a plurality of robot manufacturing instructions 6a, 6b, . . . , upon which the robot 2 is capable of operating. In this particular embodiment, the database 4 is a hard disk drive which is a part of computer architecture, further comprising a system controller 5. And the system controller 5 is a processer, which is capable of processing various digitalized instructions and select a particular instruction for the automated footwear manufacturing robot 2.

Each of the robot manufacturing instructions 6a, 6b, . . . relate to trimming a particular footwear assembly of different footwear assemblies. Each different size and model design require a unique trimming trajectory by the robot. Accordingly, each of the different robot manufacturing instructions 6a, 6b, . . . stored in the robot instructions database corresponds to a trimming operation of a particular footwear assembly.

The illustration further shows a footwear assembly 9 located in a vicinity of the robot 2, such that the robot 2 is able to apply its robot tool to the footwear assembly 9. In this particular illustration, the footwear assembly 9 is a shoe assembly, in which an upper has recently been attached to a sole via direct injection moulding, leaving a ridge requiring trimming.

The footwear assembly 9 is associated with footwear assembly identification information 14. Upon this information 14, the system controller 5 selects an elected manufacturing instruction 8 of the plurality of robot manufacturing instructions 6a, 6b, . . . , which corresponds to trimming of the particular footwear assembly 9.

This elected manufacturing instruction 8a is then provided to the robot controller 3 by the system controller 5. Accordingly, the robot controller 3 automatically executes the elected manufacturing instruction 8 to operate the automated footwear manufacturing robot 2. As a result, the robot 2 moves in a particular trajectory to apply its trimming tool to remove the ridge of the particular footwear assembly 9.

Thus, the footwear assembly 9 is partly manufactured by the footwear manufacturing robot system 1 via an elected manufacturing instruction 8 selected based on footwear assembly identification information 14 of that assembly 9.

The principles of the exemplary embodiment of FIG. 1 may also be applied to other automated footwear manufacturing tasks than the exemplified trimming task, for example some of the automated footwear manufacturing tasks exemplified within this disclosure.

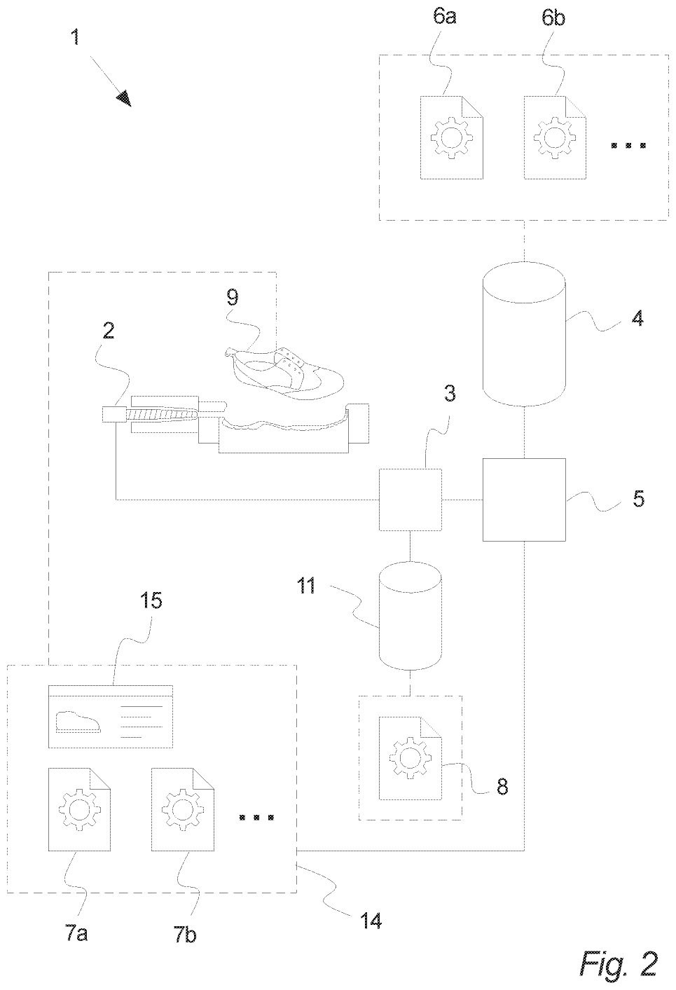

FIG. 2 illustrates schematically a footwear manufacturing robot system 1 according to another embodiment of the invention.

The embodiment of FIG. 2 has elements which are substantially similar to the embodiment of FIG. 1.

The embodiment of FIG. 2 however relates to an automated footwear manufacturing robot 2 capable of performing direct injection processing. Here, a footwear upper may be attached to a sole by injection of a polymer, e.g. polyurethane between the upper, the sole, and one or more mould parts, which together forms a casting cavity for the polymer. Upon curing of the polymer (e.g. via cooling), the polymer may then bind the upper to the sole. Alternatively, a sole may be cast directly by the polymer.

For different footwear assemblies, the required amount of injected material, and the exact composition of the material may vary. The exact composition may in turn determine hardness, colour, adhesion, flexibility etc.

Thus, when one footwear assembly is being manufactured by the automated footwear manufacturing robot 2, one manufacturing activity is necessary, and when another is footwear assembly is being manufacturing by the robot 2, another manufacturing activity is necessary. Each of the various robot manufacturing instructions 6a, 6b, . . . correspond to a direct injection processing manufacturing action of a particular footwear assembly (dependent on model design, footwear size, and model type of the footwear assembly to be manufactured).

In this embodiment, the footwear assembly 9 is associated with footwear assembly identification information, which comprises a footwear assembly ID 15, and a series of footwear manufacturing instructions 7a, 7b, . . . , which are required to be carried out to manufacture the footwear. One of these footwear manufacturing instructions 7a, 7b, . . . relate to direct injection processing of the footwear assembly 9. Others may for example relate to trimming, lacing, polishing, quality control, etc.

The footwear assembly ID 16 is a unique ID of the footwear assembly 9, which uniquely identifies the exact footwear assembly and further identifies model design, footwear size, and model type.

In this embodiment, the footwear assembly identification information 14, and hence the footwear assembly ID 16 and the footwear manufacturing instructions 7a, 7b, is tracked by the system controller 5, which autonomously tracks position and status of the various footwear assemblies being handled in the system. An automated conveyer system partially controlled by the system controller 5 is able to forward a footwear assembly to the automated footwear manufacturing robot 2.

The Footwear assembly identification information 14 can for example be stored on a footwear instructions database communicatively connected to the system controller 5. In alternative embodiments, it can be stored on a readable storage in the vicinity or on the footwear assembly 9.

As a footwear assembly is to be manufactured by the footwear manufacturing robot system 1, the system controller 5 compares the plurality of robot manufacturing instructions 6a, 6b, . . . with the series of footwear manufacturing instructions 7a, 7b, . . . to identify that a direct injection processing instruction of the robot manufacturing instructions 6a, 6b, . . . match a required direct injection processing instruction of the footwear manufacturing instructions 7a, 7b, . . . . Consequently, the system controller 5 selects this matching direct injection processing instruction of the robot manufacturing instructions 6a, 6b, . . . as an elected manufacturing instruction 8.

The elected manufacturing instruction 8 is digitally transferred from the robot instructions database 4 to a local controller database 11 communicatively connected to the robot controller 3 of the automated footwear manufacturing robot 2. From the local controller database 11, the instruction 8 is rapidly available and thus executable for the robot controller 3. Furthermore, if several similar footwear assemblies are to be processed consecutively, the elected manufacturing instruction 8 does not need to be transferred from the robot instructions database 4 to the robot controller 3 or its local controller database 11 each time an assembly is received by the automated footwear manufacturing robot 2. Instead, the instruction 8 can be reused from the local controller database 11, to minimize data transfer and increase efficiency of the system 1.

With the elected manufacturing instruction 8 on the local controller database 11, the automated footwear manufacturing robot 2 performs direct injection processing accordingly, injecting the required amount of material for the footwear assembly 9.

Thus, the footwear assembly 9 is partly manufactured by the footwear manufacturing robot system 1 via an elected manufacturing instruction 8 selected by comparing a plurality of robot manufacturing instructions 6a, 6b, . . . with a series of footwear manufacturing instructions 7a, 7b, . . . .

In this embodiment, the footwear assembly 9 is provided to the automated footwear manufacturing robot 2 on a last and inserted into the required mould parts. In other words, the footwear assembly 9 includes a last and mould parts for direct injection moulding.

In other embodiments, the automated footwear manufacturing robot 2 (or an assisting robot) inserts the footwear assembly 9 into the required mould parts as a part of the direct injection moulding instruction selected by the system controller 5.

Again, the principles of the exemplary embodiment of FIG. 2 may also be applied to other automated footwear manufacturing tasks than the exemplified direct injection processing task, for example some of the automated footwear manufacturing tasks exemplified within this disclosure.

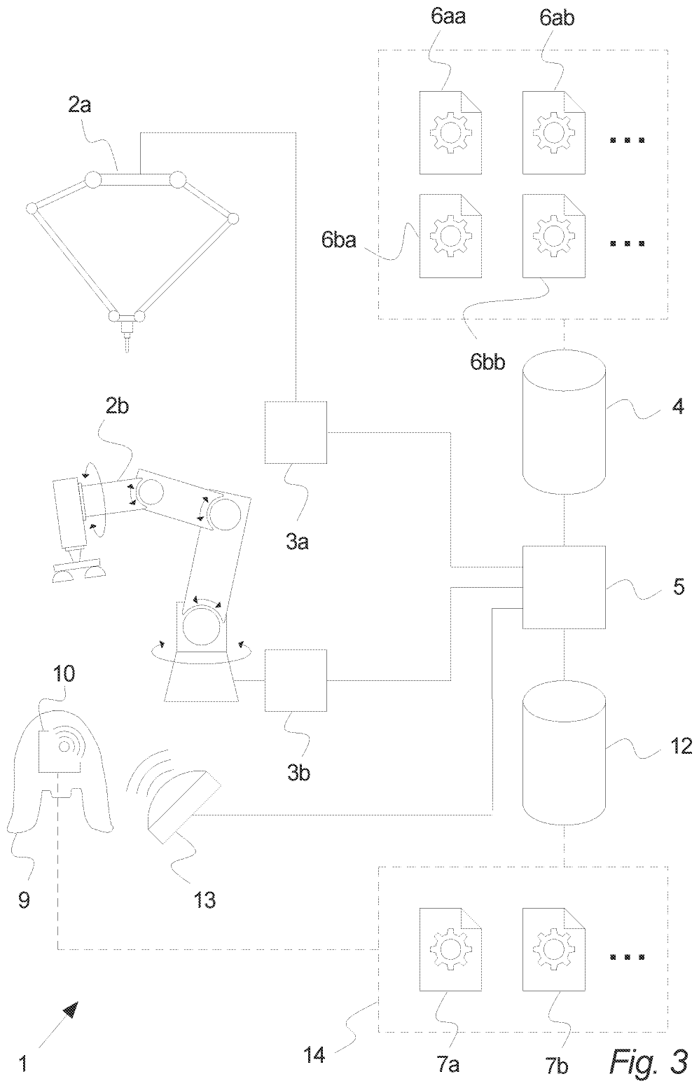

FIG. 3 illustrates schematically a footwear manufacturing robot system 1 according to an embodiment of the invention with two automated footwear manufacturing robots 2a, 2b.

The embodiment of FIG. 3 has elements which are substantially similar to the embodiments of previous FIGS. 1 and 2.

However, in contrast to previously illustrated embodiments, the embodiment in FIG. 3 comprises two automated footwear manufacturing robots 2a, 2b, each of the robots being controller by a respective robot controller 3a, 3b.

A first robot 2a of the robots 2a,2b is configured to apply glue to footwear parts. The second robot 2b of the robots 2a, 2b is configured to pick and place footwear parts, e.g. to stack/align several footwear parts of a footwear assembly on top of each other. In this particular embodiment, the first robot 2a is an automated parallel manipulator in the form of a delta robot with a glue-applying tool. The second robot 2b is a 6-axis robot arm with a vacuum pick-and-place tool.

The robot instructions database 4 comprises a plurality of robot manufacturing instructions 6aa, 6ab, 6ba, 6bb, . . . , wherein one subset 6aa, 6ab, . . . of the plurality of instructions are instructions for the first robot 2a, and another subset 6ba, 6bb, . . . of the plurality of instructions are instructions for the second robot 2b.

This embodiment further comprises a footwear instructions database 12, which comprises footwear assembly identification information 14, herein series of footwear manufacturing instructions 7a, 7b, . . . , of various footwear assemblies (note that for simplicity only one series is shown).

The automated manufacturing robot system 1 further comprises an RFID reader 13 for reading RFIDs on different footwear assemblies. Upon registering an RFID via the RFID reader 13, the footwear assembly is linked to its particular footwear assembly identification information 14 and its series of footwear manufacturing instructions 7a, 7b, . . . of the footwear instructions database 11.

In the particular illustration, a footwear assembly 9 in the form of shoe vamp with an embedded RFID 10 is located near the RFID reader 13. The RFID reader 13 is thus able to register/receive/read the RFID 10 of this exact footwear assembly to identify that footwear assembly.

The system controller 5 now links the footwear assembly 9 having the RFID to a particular series of footwear manufacturing instructions 7a, 7b, . . . of the footwear instructions database 11. Based on the series of footwear manufacturing instructions 7a, 7b, . . . and the plurality of robot manufacturing instructions 6aa, 6ab, 6ba, 6bb, . . . , the system controller 5 selects an elected manufacturing instruction. Furthermore, the system controller 5 selects a robot of the two robots 2a,2b which is to carry out the elected manufacturing instruction. The selection of a robot can for example be a direct consequence of the selection of an elected manufacturing instruction. E.g. if the elected manufacturing instruction is from one subset 6aa, 6ab, . . . , this corresponds to selecting the first robot 2a, and if the elected manufacturing instruction is from the other subset 6ba, 6bb, . . . , this corresponds to selecting the second robot 2b.

In the present context is should be noted that robot instructions may also include simple instructions such as coordinates or relevant parameters which may be applied to establish the intended operation of the robot.

In this particular illustration, the second robot 2b is selected, and hence the first robot 2a may be understood as the auxiliary automated footwear manufacturing robot. Consequently, the first robot may be understood as the (non-auxiliary) automated footwear manufacturing robot, and its robot controller 3b then automatically executes the elected manufacturing instruction to operate the second robot 2b.

Resultingly, the second robot 2b picks and places the footwear assembly 9 according to a trajectory which is based on footwear assembly identification information 14 of that footwear assembly.

As the system controller 5 selects an elected manufacturing instruction and, optionally, a robot to carry out this instruction, it can optionally take into account a footwear manufacturing sequence of the series of footwear manufacturing instructions 7a, 7b, . . . . For example, the footwear assembly 9 may require a particular placement performed by the second robot 2b, before the first robot 2a is able to correctly apply glue to the footwear assembly 9. Hence, the footwear manufacturing sequence defines that the particular manufacturing instruction corresponding to placement by the second robot 2b is performed before the particular manufacturing instruction corresponding to applying glue by the first robot 2a.

Further the system controller 5 may optionally select both a first elected manufacturing instruction for the first robot 2a and a second elected manufacturing instruction for the second robot 2b, such that these two instructions can be executed on the respective robot controllers 3a,3b simultaneously or consecutively (for example according to a footwear manufacturing sequence).

Again, the principles of the exemplary embodiment of FIG. 3 may also be applied to other automated footwear manufacturing tasks than the exemplified combination of tasks, for example any single task of combination of tasks of the automated footwear manufacturing tasks exemplified within this disclosure.

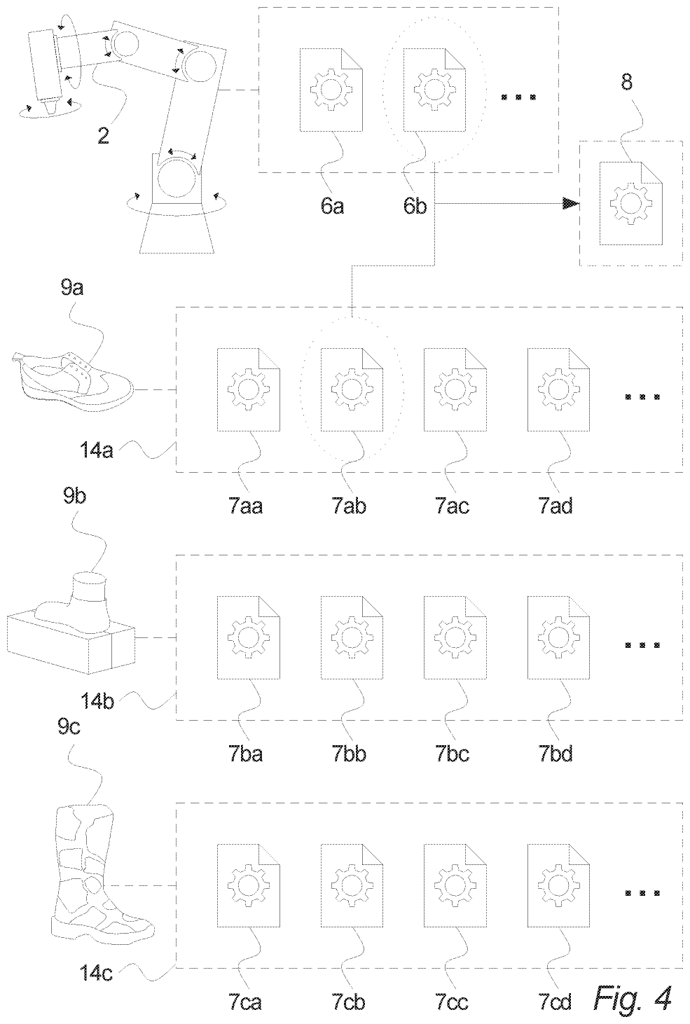

FIG. 4 illustrates a block diagram of selection of an elected manufacturing instruction 8 based on a comparison with different series of footwear manufacturing instructions (7aa, 7ab, 7ac, 7ad, . . . ; 7ba, 7bb, 7bc, 7bd, . . . ; and 7ca, 7cb, 7cc, 7cd, . . . ) according to an embodiment of the invention.

Here, an automated footwear manufacturing robot 2 is configured to manufacture different footwear assemblies at least partially. The particular robot 2 is a footwear impregnation robot, which apply a surface coating to footwear via a spraying tool.

The robot 2 is associated with a plurality of robot manufacturing instructions 6a, 6b, . . . , each of the different instructions respectively corresponding to spraying different footwear assemblies.

The footwear manufacturing robot system, which the automated footwear manufacturing robot 2 is a part of, has three different footwear assemblies 9a,9b,9c which are available for further manufacturing. A first footwear assembly 9a is associated with footwear assembly identification information 14a comprising a first series of footwear manufacturing instructions 7aa, 7ab, 7ac, 7ad, . . . , a second footwear assembly 9b is associated with footwear assembly identification information 14b comprising a second series of footwear manufacturing instructions 7ba, 7bb, 7bc, 7bd, . . . , and a third footwear assembly 9c is associated with footwear assembly identification information 14c comprising a third series of footwear manufacturing instructions 7ca, 7cb, 7cc, 7cd,

The three footwear assemblies 9a,9b,9c have different model designs, which require different manufacturing instructions for manufacturing. The first footwear assembly 9a relates to a leather shoe, the second footwear 9b assembly relates to a leather boot, while the third footwear assembly 9c relates to a rubber boot.

In the illustration, the second footwear assembly 9b is equipped with a last and mould parts, which qualifies this assembly 9b for direct injection processing.

In the embodiment, the plurality of robot manufacturing instructions 6a, 6b, . . . are compared to the different series of footwear manufacturing instructions 7aa, 7ab, 7ac, 7ad, . . . , 7ba, 7bb, 7bc, 7bd, . . . , 7ca, 7cb, 7cc, 7cd, . . . to select an elected manufacturing instruction 8. The comparison is performed by a system controller, which is not shown. In the comparison, the controller identifies whether any manufacturing instructions of the different series of different footwear manufacturing instructions 7aa, 7ab, 7ac, 7ad, . . . , 7ba, 7bb, 7bc, 7bd, . . . , 7ca, 7cb, 7cc, 7cd, . . . match any manufacturing instructions of the plurality of robot manufacturing instructions 6a, 6b, . . . .

In the exemplary embodiment, a manufacturing instruction 7ab of the first footwear assembly 9a and a manufacturing instruction 7bc of the second footwear assembly 9b match two respective manufacturing instructions of the plurality of robot manufacturing instructions 6a, 6b, . . . . In contrast, no manufacturing instruction associated with the third footwear assembly match a manufacturing instruction of the plurality of footwear manufacturing instructions.

The footwear manufacturing robot is thus in principle capable of partly manufacturing two different footwear assemblies 9a,9b. However, it can only manufacture one assembly at a time. The system controller thus further has to select which one of the footwear assemblies 9a,9b are to be manufactured next by the automated footwear manufacturing robot.

The second footwear assembly 9b is currently equipped with moulds for direct injection processing, and is thus not ready for surface coating/surface finishing via spraying yet. This unavailability for spraying may for example be facilitated by a footwear manufacturing sequence, which defines a sequence of the manufacturing instructions, for example that direct injection processing is to be performed prior to footwear impregnation.

Hence, the system controller identifies that the first footwear assembly 9a is to be manufactured via an elected manufacturing instruction 8 based on a manufacturing instruction 6b of the plurality of robot manufacturing instructions 6a, 6b, . . . which match a manufacturing instruction 7ab of the footwear manufacturing instructions 7aa, 7ab, 7ac, 7ad, . . . of this footwear assembly 9a. The first footwear assembly 9a may thus be understood as the target footwear assembly, which has been selected, e.g. by the system controller.

In other situations or embodiments, a system controller may alternatively select/deselect footwear assemblies based on parameters, constraints, and/or selection criteria such as robot manufacturing durations, footwear assembly priorities, physical locations of footwear assemblies, idle status of footwear assemblies, or any combination thereof.

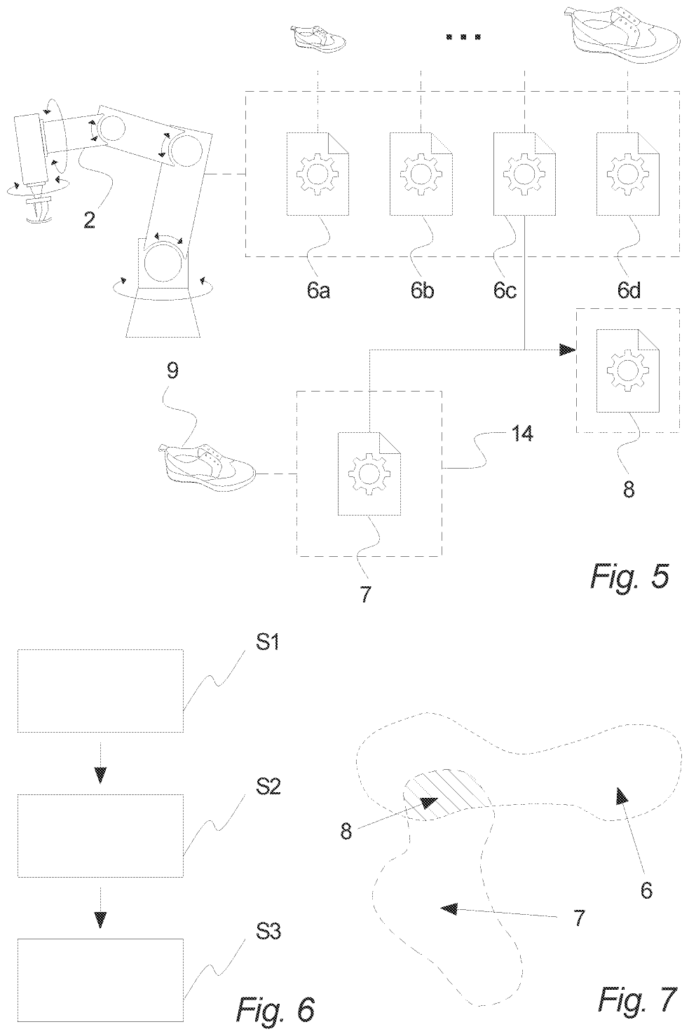

FIG. 5 illustrates a block diagram of selection of an elected manufacturing instruction 8 based on a comparison with a plurality of robot manufacturing instructions 6a, 6b, 6c, 6d relating to unique footwear sizes according to an embodiment of the invention.

Here, an automated footwear manufacturing robot 2 is configured to manufacture different footwear assemblies at least partially. The particular robot 2 is equipped with a stitching tool and is configured to stitch one or more footwear parts of a footwear assembly, for example stitch two parts together. Particularly, each manufacturing instruction of a plurality of robot manufacturing instructions 6a, 6b, 6c, 6d associated with the robot 2 relate to a stitching instruction corresponding to a particular footwear size. That is, a first manufacturing instruction 6a corresponds to stitching of a footwear assembly with a small footwear size, a last manufacturing instruction 6d corresponds to stitching of a footwear assembly with a large footwear size, and the remaining two footwear instructions 6b,6c correspond to stitching footwear assemblies with two intermediate footwear sizes.

The footwear manufacturing robot system, which the automated footwear manufacturing robot 2 is a part of, is supplied with a footwear assembly 9 comprising footwear parts which requires stitching. The footwear assembly 9 is associated with footwear assembly identification information 14 having a single footwear manufacturing instruction 7 relating to the required stitching. The footwear manufacturing instruction is compared to the plurality of robot manufacturing instructions offered by the footwear manufacturing robot system. One of the robot manufacturing instructions 6c correspond to the footwear manufacturing instruction, and that robot manufacturing instruction is then selected as an elected manufacturing instruction.

Accordingly, the robot controller (not shown), controlling automated footwear manufacturing robot 2, automatically executes the elected manufacturing instruction 8 to operate the robot 2 to partially manufacture the footwear assembly 9.

FIG. 6 illustrates method steps S1-S3 according to an embodiment of the invention.

In a first step S1, a plurality of robot manufacturing instructions are provided to a robot instructions database.

In a next step S2, an elected manufacturing instruction of the plurality of robot manufacturing instructions is selected. The elected manufacturing instruction is selected based on footwear assembly identification information associated with different footwear assemblies.

In a next step S3, the elected manufacturing instruction is automatically executed on a robot controller. The robot controller is configured to control an automated footwear manufacturing robot. By automatically executing the elected manufacturing instruction, the automated footwear manufacturing robot is operated, for example to at least partly manufacture a footwear assembly of the different footwear assemblies.

The exemplified method may optionally include further method steps, such as automatically programming a part of an elected manufacturing instruction, generating an idle signal, selecting a new elected manufacturing instruction, identifying a series of footwear manufacturing instructions, comparing compare the plurality of robot manufacturing instructions with the series of footwear manufacturing instructions, selecting a target footwear assembly, obtaining assembly proximity information, storing the elected manufacturing instruction, selecting an elected robot tool, etc. Further, note that the invention is not limited to a particular sequence of performing method steps.

FIG. 7 illustrates abstract representations of robot manufacturing instructions 6, footwear manufacturing instructions 7, and elected manufacturing instructions 8 according to an embodiment of the invention.

The robot manufacturing instructions 6 and the footwear manufacturing instructions 7 are each illustrated to form an area, representing a mathematical set of robot manufacturing instructions 6 and a mathematical set of footwear manufacturing instructions 7, respectively.

The intersectional area of these two sets form a third area/mathematical set (instruction set intersection), which represents potential elected manufacturing instructions 8.

In some embodiments, when an elected manufacturing instruction is to be selected, it can thus be selected from the set of manufacturing instructions provided by the intersection of the mathematical sets of robot manufacturing instructions 6 and footwear manufacturing instructions 7.

Note that embodiments of the invention are not limited to selection of an elected manufacturing instruction according to the abstract representations of mathematical sets.

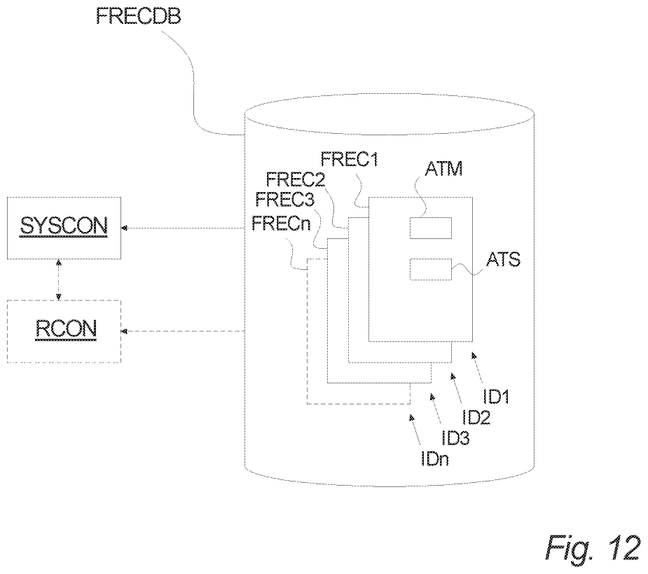

FIG. 12 illustrates an advantageous feature of an embodiment of a footwear manufacturing robot system.

FIG. 12 illustrates a footwear record database FRECDB including a plurality of footwear records FREC. Each footwear record FREC defines a unique footwear assembly to be produced and each record is associated with a unique respect footwear assembly identification information, i.e. an ID.

Each record furthermore includes at least attributes reflecting a unique model ATM and a unique size ATS associated with the respective footwear assembly.

The footwear record database FRECDB is typically centrally updated for at least a part of the overall manufacturing in the sense that footwear assemblies to be produced by a system comprising one or more of the footwear manufacturing robots are updated regularly and advantageously the respective footwear records are updated through the manufacturing process, thereby both keeping track of the total process state but also keeping track of where each footwear assembly is in the manufacturing process. Thus, the footwear record database FRECDB may a plurality of footwear records FREC1, FREC2, FREC3, FRECn each being defined by a unique associated footwear assembly identification information ID1, ID2, ID3, IDn and each record including data defining at least model design and size of the associated footwear assembly, and wherein the data defining at least model defines one out of a plurality of model designs, and where the data defining size defines one out of a plurality of sizes.

A system controller SYSCON and/or said robot controller RCON is communicatively coupled with said footwear record database FRECDB. The footwear record database FRECDB should advantageously be at least communicatively coupled with the system controller, which again communicates with the robot controllers of the manufacturing robots, thereby making it possible for the footwear manufacturing robots automatically to switch between instruction defining different model designs and sizes when a footwear assembly defined by a unique footwear assembly identification information is to be processed.

The footwear record database may be maintained an coupled with and any of the examples illustrated in the above described FIGS. 1-11.

The data defining model design is associated with respective robot manufacturing instructions, which may be stored in a relational manner in the same or another coupled database.

The data defining size is associated with respective robot manufacturing instructions which may be stored in a relational manner in the same or another coupled database.

As mentioned above, several types of operations may og must be performed when processing a footwear assembly into a footwear. The types of operations mentioned in the present application are only exemplary. Several other types of operations may be applied or some may be omitted.

More specific types of operations which may be performed advantageously at a footwear manufacturing location and/or by a footwear manufacturing robot includes e.g. a stitching robot or a direct injection robot.

An advantageous stitching robot which may advantageously be applied as a footwear manufacturing robot in the present described in PCT/DK2020/050386. The stitching robot disclosed in the document and the described method is provided to facilitate an efficient and reliable stitching in automated environment which is capable to handling different footwear designs, i.e. models, and thereby is feasible for automatically switching between different models on a run-time basis as facilitated and applied in the present context. Evidently, other types of stitching robots may be applied within the scope of the invention as long as it can switch e.g. between model and size.

Another footwear manufacturing robot which may be applied advantageously at a footwear manufacturing location within the scope of the invention is a direct injection robot (DIP), e.g. as disclosed in PCT/DK2021/050373. A direct injection within the scope of the invention is a robot moulding a sole directly onto an upper of a footwear assembly.

The disclosed DIP system, robot and method is in particular advantageous in the present context when compared to conventional DIP system (e.g. round-table systems). The conventional systems may of course be adapted to use in the present system, but the DIP system of PCT/DK2021/050373 discloses a method whereby individual curing times may be applied for different footwear assemblies and also a system where the sole moulds may be routed further on in the manufacturing line with the mould while the sole is curing. In other words, the sole may be curing while it is transported between two manufacturing locations, thereby facilitating maximum output of the DIP robot(s) and but also maximum efficiency with respect to use of footwear molds (and lasts).

Another footwear manufacturing robot which may be applied advantageously at a footwear manufacturing location within the scope of the invention is an automatic gluing robot, applied for gluing of footwear parts together, typically as an alternative to conventional stitching. An example of such a footwear manufacturing robot is disclosed in PCT/DK2020/050245.

Evidently, several other operations are suitable and attractive for use in connection with the present invention.

From the above, it is now clear that the invention relates to a footwear manufacturing robot system and a method for at least partially manufacturing footwear assemblies. An elected manufacturing instruction is chosen for an automated footwear manufacturing robot based on footwear assembly identification information. Accordingly, the automated footwear manufacturing robot can be operated to manufacture different footwear assemblies, which may improve efficiency and flexibility of footwear manufacturing.

The invention has been exemplified above with the purpose of illustration rather than limitation with reference to specific examples of footwear manufacturing robot systems and methods. Details such as a specific method and system structures have been provided in order to understand embodiments of the invention for instance it is to be understood that the embodiments disclosed in the different figures and corresponding description can be combined in any way. Note that detailed descriptions of well-known systems, devices, circuits, and methods have been omitted so as to not obscure the description of the invention with unnecessary details. It should be understood that the invention is not limited to the particular examples described above and a person skilled in the art can also implement the invention in other embodiments without these specific details. As such, the invention may be designed and altered in a multitude of varieties within the scope of the invention as specified.

### LIST OF REFERENCE SIGNS

1 Footwear manufacturing robot system
2 Automated footwear manufacturing robot
3 Robot controller
4 Robot instructions database
5 System controller
6 Robot manufacturing instruction
7 Footwear manufacturing instruction
8 Elected manufacturing instruction
9 Footwear assembly
10 RFID
11 Local controller database
12 Footwear instructions database
13 RFID reader
14 Footwear assembly identification information
15 Footwear assembly ID
S1-S3 Method steps
FMRS Footwear manufacturing robot system
AFMR Automated footwear manufacturing robot
RCON Robot controller
RIDB Robot instructions database
SCON System controller
RMI Robot manufacturing instruction
FMI Footwear manufacturing instruction
EMI Elected manufacturing instruction
FA Footwear assembly
FLINE Footwear manufacturing line
FAC Footwear assembly carrier
FML Footwear manufacturing location
FLOC First location
SLOC Second location
IDM Identity marking
CIDM Carrier identity marking
IDR Identity reader
FMR Footwear manufacturing robot
FLINER Footwear manufacturing line return path
FAA Footwear assembly attribute
FAM Footwear assembly model
FPS First process step
SPS Second process step
TP Transportation paths

1. A footwear manufacturing system comprising:
a footwear assembly;
a footwear identification representation associated with said footwear assembly;
a plurality of footwear manufacturing locations;
a footwear manufacturing line for conveying said footwear assembly between said plurality of footwear manufacturing locations under control by a system controller and/or a robot controller; and
wherein the system controller is configured to monitor said footwear assembly when the footwear assembly is transported from a first location of said plurality of footwear manufacturing locations to a second location of said plurality of footwear manufacturing locations based on said footwear identification representation.

2. The footwear manufacturing system according to claim 1, the system controller and/or the robot controller being configured to control transporting of said footwear assembly from a first location of said plurality of footwear manufacturing locations to a second location of said plurality of footwear manufacturing locations based on said footwear identification representation.

3. (canceled)

4. The footwear manufacturing system according to claim 1, wherein the footwear assembly is monitored by reading an ID marking attached to the footwear assembly and/or reading an ID marking attached to footwear part(s) to be gathering with and attached to the footwear assembly, and
wherein the footwear assembly is monitored at least one time during transport from the first location to the second location based on an associated marking or transport information communicated to the system controller.

5. The footwear manufacturing system according to claim 1, wherein said footwear manufacturing line including a plurality of footwear assembly carriers configured for transporting footwear assemblies between at least a subset of said plurality of footwear manufacturing locations under control by said system controller.

6. The footwear manufacturing system according to claim 1, wherein the footwear identification representation is applied for automatic reconfiguration of a footwear manufacturing robot based on said footwear identification representation when the respective footwear assembly is in proximity of a location of said footwear manufacturing robot.

7. The footwear manufacturing system according to claim 1, wherein the footwear identification representation is applied for automatic initialization of a reconfiguration of a footwear manufacturing robot based on said footwear identification representation before the respective footwear assembly is in position for processing by means of said footwear manufacturing robot at the footwear manufacturing location.

8. The footwear manufacturing system according to claim 1, wherein the footwear identification representation of a footwear assembly is correlated to at least one footwear assembly attribute.

9. (canceled)

10. The footwear manufacturing system according to claim 1, wherein the footwear identification representation of a footwear assembly is correlated to at least one further footwear assembly attribute, said further footwear assembly attribute including footwear assembly size.

11. The footwear manufacturing system according to claim 1, wherein the footwear manufacturing line is configured for automatically routing a plurality of footwear assemblies between a plurality of footwear manufacturing robots at corresponding different footwear manufacturing locations based on said footwear identification representation.

12. The footwear manufacturing system according to claim 1, wherein the footwear manufacturing line is configured for automatically routing a plurality of footwear assemblies between a plurality of footwear manufacturing robots at corresponding different footwear manufacturing locations based on said footwear identification representation,
wherein the footwear manufacturing system further comprises the plurality of footwear manufacturing robots configured for performing a first process step,
wherein the wherein the footwear manufacturing system comprises a plurality of footwear manufacturing robots configured for performing a second process step, and
wherein the first process step is functionally different than the second process step.

13. The footwear manufacturing system according to claim 1, wherein the footwear manufacturing line is configured for automatically routing a plurality of footwear assemblies between a plurality of footwear manufacturing robots at corresponding different footwear manufacturing locations based on said footwear identification representation, and
wherein the footwear assemblies are transported by footwear assembly carriers between the footwear manufacturing locations controlled by the system controller and optionally also the robot controller(s).

14. The footwear manufacturing system according to claim 5, wherein the plurality of the footwear assembly carriers are configured for carrying one or a pair of footwear assemblies between the footwear manufacturing locations.

15. The footwear manufacturing system according to claim 5, wherein the plurality of the footwear assembly carriers are configured for carrying a plurality of footwear assemblies between the footwear manufacturing locations.

16. The footwear manufacturing system according to claim 5, wherein the plurality of the footwear assembly carriers are configured as a multiple of transportation paths between said footwear manufacturing locations and wherein said transportation paths are branched so as to switch footwear assembly carriers between different alternative footwear manufacturing locations for a same process step/task.

17. The footwear manufacturing system according to claim 1, including a footwear manufacturing robot system comprising:
an automated footwear manufacturing robot;
a robot controller configured to control said automated footwear manufacturing robot;
a robot instructions database comprising a plurality of robot manufacturing instructions; and
a system controller communicatively coupled to said robot instructions database and said robot controller,
wherein said automated footwear manufacturing robot is configured to manufacture different footwear assemblies at least partially, each of different footwear assemblies associated with footwear assembly identification information,
wherein said system controller and/or said robot controller is configured to select an elected manufacturing instruction of said plurality of robot manufacturing instructions based on said footwear assembly identification information, and
wherein said robot controller is configured to automatically execute said elected manufacturing instruction to operate said automated footwear manufacturing robot.

18.-27. (canceled)

28. The footwear manufacturing system according to claim 17, wherein said plurality of robot manufacturing instructions is associated with at least two different robot tools.

29. The footwear manufacturing system according to claim 17, wherein a series of footwear manufacturing instructions are updated after completion of executing said elected manufacturing instruction to operate said automated footwear manufacturing robot.

30. (canceled)

31. The footwear manufacturing system according to claim 1, wherein the system controller and/or the robot controller is configured to control transporting of said footwear assembly from a first location of said plurality of footwear manufacturing locations to a second location of said plurality of footwear manufacturing locations based on said footwear identification representation, the second location being one of a least two different alternative possible footwear manufacturing locations.

32. (canceled)

33. The footwear manufacturing system according to claim 31, wherein the footwear manufacturing system executes a method for manufacturing footwear, whereby transportation of individual footwear assemblies are monitored during transport through the footwear manufacturing line, and
whereby individual footwear assemblies are routed through a branched transportation path by the system controller.

34. The footwear manufacturing system according to claim 33, wherein the method for manufacturing footwear, includes steps of:
providing a plurality of robot manufacturing instructions to a robot instructions database;
selecting an elected manufacturing instruction of said plurality of robot manufacturing instructions based on footwear assembly identification information associated with different footwear assemblies; and
automatically executing said elected manufacturing instruction on a robot controller configured to control an automated footwear manufacturing robot to operate said automated footwear manufacturing robot.

35. (canceled)
